(19) United States
(12) Patent Application Publication
(10) Pub. No.: US 2024/0352254 A1
(43) Pub. Date: Oct. 24, 2024

(54) Thermoplastic Vulcanizates Having Lower Carbon Footprint

(71) Applicant: Celanese International Corporation, Irving, TX (US)

(72) Inventor: Prashant Bhadane, Houston, TX (US)

(21) Appl. No.: 18/641,511

(22) Filed: Apr. 22, 2024

Related U.S. Application Data
(60) Provisional application No. 63/497,514, filed on Apr. 21, 2023.

(51) Int. Cl. C08L 91/00

(52) U.S. Cl. CPC C08L 91/00; C08L 2207/04

(57) ABSTRACT

A method of forming a thermoplastic vulcanizate and a thermoplastic vulcanizate are disclosed. The method comprises dynamically vulcanizing a formulation comprising a thermoplastic resin, an elastomer, an oil comprising a re-refined oil, and a curing agent to provide the thermoplastic vulcanizate comprising the thermoplastic resin and an at least partially cured elastomer. The thermoplastic vulcanizate comprises a thermoplastic resin in an amount of 5 wt. % or more based on the weight of the thermoplastic vulcanizate, an at least partially cured elastomer in an amount of 5 wt. % or more based on the weight of the thermoplastic vulcanizate, and an oil comprising a re-refined oil.

### CROSS-REFERENCE TO RELATED APPLICATION

The present application claims filing benefit of U.S. Provisional Patent Application No. 63/497,514 having a filing date of Apr. 21, 2023, which is hereby incorporated by reference in its entirety.

### BACKGROUND OF THE INVENTION

In general, thermoplastic vulcanizates can be formed by dynamically vulcanizing a formulation including a thermoplastic resin and an elastomer. During the process, other additives may also be provided for various benefits and/or obtaining certain desired properties in a resulting thermoplastic vulcanizate. For example, an oil may be provided to assist with the processability of the materials in the formulation and forming the thermoplastic vulcanizate. In addition, various additives such as colorants and/or fillers may be provided to obtain certain desired properties in a resulting thermoplastic vulcanizate. Typically, the additives utilized in forming the thermoplastic vulcanizate are virgin materials. For instance, oils typically utilized are made from crude oil and may carry a higher carbon footprint.

As such, a need currently exists for providing a thermoplastic vulcanizate having a relatively lower carbon footprint with a relatively higher recycled content while still retaining a balanced performance along with providing an improved method of forming a thermoplastic vulcanizate.

### SUMMARY OF THE INVENTION

In accordance with one embodiment of the present disclosure, a method of forming a thermoplastic vulcanizate is disclosed. The method comprises dynamically vulcanizing a formulation comprising a thermoplastic resin, an elastomer, an oil comprising a re-refined oil, and a curing agent to provide the thermoplastic vulcanizate comprising the thermoplastic resin and an at least partially cured elastomer.

In accordance with another embodiment of the present disclosure, a thermoplastic vulcanizate is disclosed. The thermoplastic vulcanizate comprises a thermoplastic resin in an amount of 5 wt. % or more based on the weight of the thermoplastic vulcanizate, an at least partially cured elastomer in an amount of 5 wt. % or more based on the weight of the thermoplastic vulcanizate, and an oil comprising a re-refined oil.

Other features and aspects of the present disclosure are set forth in greater detail below.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to a method of forming a thermoplastic vulcanizate. The method particularly utilizes a re-refined oil. For instance, generally, the method may include a step of dynamically vulcanizing a formulation comprising a thermoplastic resin, an elastomer, an oil comprising a re-refined oil, and a curing agent to provide the thermoplastic vulcanizate comprising the thermoplastic resin and an at least partially cured elastomer. In this regard, the present inventor has discovered that by utilizing a re-refined oil as disclosed therein, the resulting thermoplastic vulcanizate may yield the desired properties while also providing a method and resulting thermoplastic vulcanizate that is more environmentally friendly. Accordingly, the method allows for higher sustainability attributes than certain other general methods and also provides a reduction in the overall carbon footprint of the thermoplastic vulcanizate.

Various embodiments of the present disclosure will now be described in more detail.

### I. Thermoplastic Vulcanizate

### A. Thermoplastic Resin

As indicated above, the thermoplastic vulcanizate contains a thermoplastic resin. In this regard, the thermoplastic vulcanizate may contain one or more thermoplastic resins. In one embodiment, one thermoplastic resin may be utilized as the thermoplastic resin. In other embodiments, the thermoplastic resin may include a mixture of thermoplastic resins. For instance, more than one thermoplastic resin, such as two or three thermoplastic resins, may be utilized in the thermoplastic vulcanizate. Furthermore, the thermoplastic resin may be a homopolymer or a copolymer. In one embodiment, the thermoplastic resin may be a homopolymer. In another embodiment, the thermoplastic resin may be a copolymer.

In general, any thermoplastic resin suitable for use in the manufacture of a thermoplastic vulcanizate can be employed as the thermoplastic resin. For instance, the thermoplastic resin may include a polyolefin, a polyimide, a polyester, a polyamide, poly(phenylene ether), a polycarbonate, a styrene-acrylonitrile copolymer, polyethylene terephthalate, polybutylene terephthalate, polystyrene, polystyrene derivatives, polyphenylene oxide, polyoxymethylene, fluorine-containing thermoplastic resins, or a mixture thereof.

In one embodiment, the thermoplastic resin may include at least a polyolefin. The polyolefin can be formed by polymerizing one or more alpha-olefins such as ethylene, propylene, 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene or ethylene or propylene with another alpha-olefin such as 1-butene, 1-hexene, 1-octene, 2-methyl-1-propene, 3-methyl-1-pentene, 4-methyl-1-pentene, 5-methyl-1-hexene or mixtures thereof may be also utilized in accordance with the present disclosure. In one embodiment, when the primary monomer is ethylene, the copolymer may be propylene or another C₄-C₈ alpha-olefin monomer. In one embodiment, the comonomer may be propylene. In another embodiment, the comonomer may be a C₄-C₈ alpha-olefin monomer, such as hexene. When the primary monomer is propylene, the copolymer may be ethylene or another C₄-C₈ alpha-olefin monomer. In one embodiment, the comonomer may be ethylene. In another embodiment, the comonomer may be a C₄-C₈ alpha-olefin monomer.

Other suitable polyolefin copolymers may include copolymers of olefins with styrene such as styrene-ethylene copolymer or polymers of olefins with α, β-unsaturated acids, α, β-unsaturated esters such as polyethylene-acrylate copolymers. Non-olefin thermoplastic resins may include polymers and copolymers of styrene, α, β-unsaturated acids, α, β-unsaturated esters, and mixtures thereof. For example, polystyrene, polyacrylate, and polymethacrylate may be used.

When the thermoplastic resin includes a polyolefin copolymer formed of ethylene or propylene as the primary monomer, the corresponding comonomer may be present in an amount of 0.1 wt. % or more, such as 0.5 wt. % or more, such as 1 wt. % or more, such as 2 wt. % or more, such as 5 wt. % or more, such as 10 wt. % or more, such as 15 wt. % or more, such as 20 wt. % or more based on the weight of the copolymer. The comonomer may be present in an amount of 40 wt. % or less, such as 30 wt. % or less, such as 25 wt. % or less, such as 20 wt. % or less, such as 15 wt. % or less, such as 10 wt. % or less, such as 8 wt. % or less, such as 6 wt. % or less, such as 5 wt. % or less based on the weight of the copolymer. Similarly, the corresponding comonomer may be present in an amount of 0.1 mol. % or more, such as 0.5 mol. % or more, such as 1 mol. % or more, such as 2 mol. % or more, such as 5 mol. % or more, such as 10 mol. % or more, such as 15 mol. % or more, such as 20 mol. % or more based on the total number of moles in the copolymer. The comonomer may be present in an amount of 40 mol. % or less, such as 30 mol. % or less, such as 25 mol. % or less, such as 20 mol. % or less, such as 15 mol. % or less, such as 10 mol. % or less, such as 8 mol. % or less, such as 6 mol. % or less, such as 5 mol. % or less based on the total number of moles in the copolymer.

In one embodiment, the polyolefin may be an ethylene polymer, a propylene polymer, or a mixture thereof. In this regard, in one embodiment, the polyolefin may be an ethylene polymer. In another embodiment, the polyolefin may be a propylene polymer. In a further embodiment, the polyolefin may be a mixture of an ethylene polymer and a propylene polymer.

The ethylene polymer may be a polyethylene homopolymer in one embodiment. In another embodiment, the ethylene polymer may be an ethylene copolymer.

In addition to the above, in one embodiment, the ethylene polymer may have a particular density. For instance, the density may be from about 0.80 g/cm³ to about 1 g/cm³, such as from about 0.84 g/cm³ to about 0.99 g/cm³, such as from about 0.84 g/cm³ to about 0.94 g/cm³, such as from about 0.85 g/cm³ to about 0.94 g/cm³, such as from about 0.91 g/cm³ to about 0.94 g/cm³. In this regard, the ethylene polymer may be a linear low-density polyethylene (LLDPE), a low density polyethylene (LDPE), a medium density polyethylene (MDPE), a high density polyethylene (HDPE), or a mixture thereof. Such polyethylenes may have a particular density as determined in accordance with ASTM D792. For instance, a linear low-density polyethylene (LLDPE) may have a density in the range of from about 0.91 g/cm³ to about 0.94 g/cm³. Meanwhile, a low-density polyethylene (LDPE) may have a density in the range of from about 0.91 g/cm³ to about 0.925 g/cm³. A medium density polyethylene (MDPE) may have a density in the range of from about 0.926 g/cm³ to about 0.94 g/cm³. Also, a high-density polyethylene (HDPE) may have density in the range of from about 0.941 g/cm³ to about 0.965 g/cm³. In one embodiment, the ethylene polymer may be a low-density polyethylene. In another embodiment, the ethylene polymer may be a linear low-density polyethylene. In a further embodiment, the ethylene polymer may be a medium density polyethylene.

The propylene polymer may be a polypropylene homopolymer in one embodiment. In another embodiment, the propylene polymer may be a polypropylene copolymer. Furthermore, the polypropylene polymer may be isotactic or syndiotactic polypropylene. For instance, the polypropylene polymer may be isotactic polypropylene in one embodiment. In another embodiment, the polypropylene polymer may be syndiotactic polypropylene.

These homopolymers and copolymers may be synthesized using any polymerization technique known in the art such as, but not limited to, the Phillips catalyzed reactions, conventional Ziegler-Natta type polymerizations, and metallocene catalysis including, but not limited to, metallocene-alumoxane and metallocene-ionic activator catalysis. Suitable catalyst systems thus include chiral metallocene catalyst systems, see, e.g., U.S. Pat. No. 5,441,920, and transition metal-centered, heteroaryl ligand catalyst systems, see, e.g., U.S. Pat. No. 6,960,635.

In one embodiment, the thermoplastic resin may include a recycled thermoplastic resin. For instance, the recycled thermoplastic resin may be one that is a pre-consumer material, a post-industrial material, or a post-consumer material as defined in accordance with ISO 14021 with the exclusion of materials that are capable of being reclaimed within the same process in which it was generated. The thermoplastic resin may include a mixture of one or more virgin thermoplastic resins and one or more recycled thermoplastic resins. The recycled thermoplastic resin may constitute the majority of the thermoplastic resin by weight in one embodiment. In this regard, it may be present in an amount of greater than 50 wt. % based on the total weight of thermoplastic resin in the thermoplastic vulcanizate. In another embodiment, the recycled thermoplastic resin may constitute a minority of the thermoplastic resin by weight. In this regard, it may be present in an amount of less than 50 wt. % based on the total weight of thermoplastic resin in the thermoplastic vulcanizate. In a further embodiment, the recycled thermoplastic resin may be provided in equal parts by weight as virgin thermoplastic resin(s). The thermoplastic resin of the recycled thermoplastic resin may be any of the aforementioned thermoplastic resins.

The recycled thermoplastic resin may be a recycled thermoplastic resin of any of the aforementioned thermoplastic resins mentioned herein. In one embodiment, the recycled thermoplastic resin may include a recycled polyolefin. For instance, the recycled thermoplastic resin may include a recycled polypropylene, a recycled polyethylene, or a mixture thereof. In one particular embodiment, the recycled thermoplastic resin may include a recycled polypropylene. In another particular embodiment, the recycled thermoplastic resin may include a recycled polyethylene. In a further particular embodiment, the recycled thermoplastic resin may include a mixture of a recycled polyethylene and a recycled polypropylene.

In general, the thermoplastic resin can include a solid, generally high molecular weight polymeric material. The thermoplastic resin may have a Mw of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mw may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less. Furthermore, the thermoplastic resin may have a Mn of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mn may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less. In general, the molecular weight may be characterized by GPC (gel permeation chromatography) using polystyrene standards.

The thermoplastic resin may be a crystalline polymer in one embodiment or a semi-crystalline polymer in another embodiment. For instance, the crystallinity may be at least 25%, such as at least 35%, such as at least 45%, such as at least 55%, such as at least 65%, such as at least 70% by weight. The crystallinity may be determined by differential scanning calorimetry. For instance, crystallinity may be determined by dividing the heat of fusion of a sample by the heat of fusion of a 100% crystalline polymer.

The thermoplastic resin may also have a particular glass transition temperature (“Tg”). For instance, the glass transition temperature may be relatively high. In this regard, the Tg may be about −120° C. or more, such as −110° C. or more, such as −100° C. or more, such as −90° C. or more, such as −70° C. or more, such as −50° C. or more, such as −30° C. or more, such as −25° C. or more, such as −20° C. or more, such as −15° C. or more, such as −10° C. or more, such as −5° C. or more, such as 0° C. or more, such as 5° C. or more, such as 10° C. or more, such as 20° C. or more, such as 30° C. or more, such as 50° C. or more, such as 80° C. or more, such as 100° C. or more, such as 120° C. or more, such as 140° C. or more, such as 160° C. or more, such as 180° C. or more, such as 200° C. or more. The Tg may be about 300° C. or less, such as 260° C. or less, such as 220° C. or less, such as 180° C. or less, such as 140° C. or less, such as 100° C. or less, such as 80° C. or less, such as 60° C. or less, such as 40° C. or less, such as 30° C. or less, such as 20° C. or less, such as 10° C. or less, such as 5° C. or less, such as 0° C. or less, such as −5° C. or less.

In addition, the thermoplastic resin may have a particular melt temperature (“Tm”). For instance, the melt temperature of the thermoplastic resin may be relatively high. Furthermore, the melt temperature of the thermoplastic resin may be lower than the decomposition temperature of the elastomer in the thermoplastic vulcanizate, such decomposition temperature generally characterized as when the molecular bonds begin to break or scission such that the molecular weight of the elastomer begins to decrease. In this regard, the Tm may be about 100° C. or more, such as 120° C. or more, such as 140° C. or more, such as 150° C. or more, such as 160° C. or more, such as 170° C. or more, such as 180° C. or more, such as 190° C. or more, such as 200° C. or more, such as 240° C. or more, such as 280° C. or more. The Tm may be about 400° C. or less, such as 360° C. or less, such as 320° C. or less, such as 300° C. or less, such as 280° C. or less, such as 250° C. or less, such as 220° C. or less, such as 200° C. or less, such as 180° C. or less, such as 160° C. or less.

The thermoplastic resin may also be characterized as having a particular heat of fusion. For instance, the heat of fusion may be about 0.1 J/g or more, such as about 1 J/g or more, such as about 2 J/g or more, such as about 5 J/g or more, such as about 10 J/g or more, such as about 10 J/g or more, such as about 30 J/g or more, such as 40 J/g or more, such as 50 J/g or more, such as 60 J/g or more, such as 70 J/g or more, such as 100 J/g or more, such as 120 J/g or more, such as 140 J/g or more, such as 160 J/g or more, such as 180 J/g or more, such as 200 J/g or more. The heat of fusion may be about 300 J/g or less, such as about 260 J/g or less, such as about 240 J/g or less, such as about 200 J/g or less, such as about 180 J/g or less, such as about 150 J/g or less, such as about 120 J/g or less, such as about 100 J/g or less, such as about 80 J/g or less, such as about 60 J/g or less, such as about 50 J/g or less, such as about 40 J/g or less, such as about 30 J/g or less, such as about 20 J/g or less.

The thermoplastic resin may have a melt flow rate of up to 400 g/10 min. In general, the thermoplastic resin may have better properties where the melt flow rate is less than about 30 g/10 min., preferably less than 10 g/10 min, such as less than about 2 g/10 min, such as less than about 1 g/10 min, such as less than about 0.8 g/10 min. In general, the melt flow rate may be 0.1 g/10 min or more, such as 0.2 g/10 min or more, such as 0.3 g/10 min or more, such as 0.4 g/10 min or more, such as 0.5 g/10 min or more. Melt flow rate is a measure of how easily a polymer flows under standard pressure and is measured by using ASTM D-1238 at 190° C. and 2.16 kg load.

The thermoplastic resin may be present in an amount of about 10 phr or more, such as about 20 phr or more, such as about 30 phr or more, such as about 40 phr or more, such as about 50 phr or more, such as about 60 phr or more, such as about 70 phr or more, such as about 80 phr or more, such as about 90 phr or more, such as about 100 phr or more, such as about 150 phr or more, such as about 200 phr or more, such as about 250 phr or more, such as about 300 phr or more. The thermoplastic resin may be present in an amount of about 750 phr or less, such as about 700 phr or less, such as about 600 phr or less, such as about 500 phr or less, such as about 400 phr or less, such as about 350 phr or less, such as about 300 phr or less, such as about 250 phr or less, about 200 phr or less, such as about 180 phr or less, such as about 160 phr or less, such as about 140 phr or less, such as about 120 phr or less, such as about 100 phr or less, such as about 90 phr or less, such as about 80 phr or less, such as about 70 phr or less, such as about 60 phr or less, such as about 50 phr or less.

The thermoplastic vulcanizate and/or formulation may generally comprise about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 50 wt. % or more, such as about 60 wt. % or more of the thermoplastic resin. The thermoplastic vulcanizate and/or formulation may comprise about 90 wt. % or less, such as about 80 wt. % or less, such as about 70 wt. % or less, such as about 60 wt. % or less, such as about 50 wt. % or less, such as about 40 wt. % or less, such as about 35 wt. % or less of the thermoplastic resin. In another embodiment, such aforementioned weight percentages may be based on the combined weight of the thermoplastic resin and the elastomer combined within the thermoplastic vulcanizate.

When the thermoplastic vulcanizate includes a first thermoplastic resin and a second thermoplastic resin, they may be present in certain amounts. For instance, the thermoplastic resin may generally comprise about 5 wt. % or more, such as about 8 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 50 wt. % or more, such as about 60 wt. % or more, such as about 70 wt. % or more, such as about 80 wt. % or more, such as about 90 wt. % or more of the first thermoplastic resin. The thermoplastic resin may comprise about 98 wt. % or less, such as about 95 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 30 wt. % or less, such as about 20 wt. % or less, such as about 15 wt. % or less, such as about 10 wt. % or less of the first thermoplastic resin.

The thermoplastic resin may generally comprise about 5 wt. % or more, such as about 8 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 50 wt. % or more, such as about 60 wt. % or more, such as about 70 wt. % or more, such as about 80 wt. % or more, such as about 90 wt. % or more of the second thermoplastic resin. The thermoplastic resin may comprise about 98 wt. % or less, such as about 95 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 30 wt. % or less, such as about 20 wt. % or less, such as about 15 wt. % or less, such as about 10 wt. % or less of the second thermoplastic resin.

The weight ratio of the first thermoplastic resin to the second thermoplastic resin may be about 0.01 or more, such as about 0.05 or more, such as about 0.1 or more, such as about 0.2 or more, such as about 0.3 or more, such as about 0.4 or more, such as about 0.5 or more, such as about 0.6 or more, such as about 0.7 or more, such as about 0.8 or more, such as about 0.9 or more, such as about 1 or more, such as about 1.2 or more, such as about 1.4 or more, such as about 1.6 or more, such as about 1.8 or more, such as about 2 or more, such as about 2.5 or more, such as about 3 or more, such as about 3.5 or more, such as about 4 or more, such as about 4.5 or more, such as about 5 or more. The weight ratio may be about 40 or less, such as about 35 or less, such as about 30 or less, such as about 28 or less, such as about 26 or less, such as about 24 or less, such as about 22 or less, such as about 20 or less, such as about 18 or less, such as about 16 or less, such as about 14 or less, such as about 12 or less, such as about 10 or less, such as about 9 or less, such as about 8 or less, such as about 7 or less, such as about 6 or less, such as about 5 or less, such as about 4.5 or less, such as about 4 or less, such as about 3.5 or less, such as about 3 or less, such as about 2.5 or less, such as about 2 or less, such as about 1.8 or less, such as about 1.6 or less, such as about 1.4 or less, such as about 1.2 or less, such as about 1 or less, such as about 0.8 or less, such as about 0.6 or less, such as about 0.4 or less.

As indicated above, in one embodiment, the thermoplastic resin may include a recycled thermoplastic resin. The thermoplastic resin may generally comprise about 1 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 50 wt. % or more, such as about 60 wt. % or more, such as about 70 wt. % or more, such as about 80 wt. % or more, such as about 90 wt. % or more of the recycled thermoplastic resin. The thermoplastic resin may comprise about 100 wt. % or less, such as about 98 wt. % or less, such as about 95 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 30 wt. % or less, such as about 20 wt. % or less, such as about 15 wt. % or less, such as about 10 wt. % or less, such as about 5 wt. % or less of the recycled thermoplastic resin.

The weight ratio of virgin thermoplastic resin(s) to recycled thermoplastic resin(s) may be about 0.01 or more, such as about 0.05 or more, such as about 0.1 or more, such as about 0.2 or more, such as about 0.3 or more, such as about 0.4 or more, such as about 0.5 or more, such as about 0.6 or more, such as about 0.7 or more, such as about 0.8 or more, such as about 0.9 or more, such as about 1 or more, such as about 1.2 or more, such as about 1.4 or more, such as about 1.6 or more, such as about 1.8 or more, such as about 2 or more, such as about 2.5 or more, such as about 3 or more, such as about 3.5 or more, such as about 4 or more, such as about 4.5 or more, such as about 5 or more. The weight ratio may be about 40 or less, such as about 35 or less, such as about 30 or less, such as about 28 or less, such as about 26 or less, such as about 24 or less, such as about 22 or less, such as about 20 or less, such as about 18 or less, such as about 16 or less, such as about 14 or less, such as about 12 or less, such as about 10 or less, such as about 9 or less, such as about 8 or less, such as about 7 or less, such as about 6 or less, such as about 5 or less, such as about 4.5 or less, such as about 4 or less, such as about 3.5 or less, such as about 3 or less, such as about 2.5 or less, such as about 2 or less, such as about 1.8 or less, such as about 1.6 or less, such as about 1.4 or less, such as about 1.2 or less, such as about 1 or less, such as about 0.8 or less, such as about 0.6 or less, such as about 0.4 or less.

### B. Elastomer

As indicated above, the thermoplastic vulcanizate contains an elastomer. For instance, due to the dynamic vulcanization, the thermoplastic vulcanizate contains an at least partially cured elastomer. In general, any elastomer suitable for use in the manufacture of TPVs can be utilized in accordance with the present disclosure. In one embodiment, one elastomer may be utilized as the elastomer. In other embodiments, the elastomer may include a mixture of elastomers. For instance, more than one elastomer, such as two or three elastomers, may be utilized in the thermoplastic vulcanizate.

Any elastomer or mixture thereof that is capable of being vulcanized (that is crosslinked or cured) can be used as the elastomer (also referred to herein sometimes as the rubber). Reference to a rubber or elastomer may include mixtures of more than one. Useful elastomers typically contain a degree of unsaturation in their polymeric main chain. Some non-limiting examples of these rubbers include polyolefin copolymer elastomers, butyl rubber, natural rubber, styrene-butadiene copolymer rubber (e.g., styrene/ethylene-butadiene/styrene), butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlolorohydrin terpolymer rubber, and polychloroprene.

Vulcanizable elastomers include polyolefin copolymer elastomers. These copolymers are made from one or more of ethylene and higher alpha-olefins, which may include, but are not limited to propylene, 1-butene, 1-hexene, 4-methyl-1 pentene, 1-octene, 1-decene, or combinations thereof, plus one or more copolymerizable, multiply unsaturated comonomer, such as diolefins, or diene monomers. The alpha-olefins can be propylene, 1-hexene, 1-octene, or combinations thereof. These rubbers may lack substantial crystallinity and can be suitably amorphous copolymers.

The diene monomers may include, but are not limited to, 5-ethylidene-2-norbornene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; 5-vinyl-2-norbornene, divinyl benzene, and the like, or a combination thereof. The diene monomers can be 5-ethylidene-2-norbornene and/or 5-vinyl-2-norbornene. If the copolymer is prepared from ethylene, alpha-olefin, and diene monomers, the copolymer may be referred to as a terpolymer (EPDM rubber), or a tetrapolymer in the event that multiple alpha-olefins or dienes, or both, are used (EAODM rubber).

Elastomers that are polyolefin elastomer copolymers can contain from about 15 to about 90 mole percent ethylene units deriving from ethylene monomer, from about 40 to about 85 mole percent, or from about 50 to about 80 mole percent ethylene units. The copolymer may contain from about 10 to about 85 mole percent, or from about 15 to about 50 mole percent, or from about 20 to about 40 mole percent, alpha-olefin units deriving from alpha-olefin monomers. The foregoing mole percentages are based upon the total moles of the mer units of the polymer. Where the copolymer contains diene units, the copolymers may contain from 0.1 to about 14 weight percent, from about 0.2 to about 13 weight percent, or from about 1 to about 12 weight percent units deriving from diene monomer. The weight percent diene units deriving from diene may be determined according to ASTM D-6047. In some occurrences, the copolymers contain less than 5.5 weight percent, such as less than 5.0 weight percent, such as less than 4.5 weight percent, such as less than 4.0 weight percent units deriving from diene monomer. In yet other cases, the copolymers contain greater than 6.0 weight percent, such as greater than 6.2 weight percent, such as greater than 6.5 weight percent, such as greater than 7.0 weight percent units, such as greater than 8.0 weight percent deriving from diene monomer.

The polyolefin elastomer copolymer may be obtained using polymerization techniques known in the art such as traditional solution or slurry polymerization processes. For instance, the catalyst employed to polymerize the ethylene, alpha-olefin, and diene monomers into elastomeric copolymers can include both traditional Ziegler-Natta type catalyst systems, especially those including titanium and vanadium compounds, as well as metallocene catalysts for Group 3-6 (titanium, zirconium and hafnium) metallocene catalysts, particularly the bridged mono- or biscyclopentadienyl metallocene catalysts. Other catalyst systems such as Brookhart catalyst systems may also be employed.

In one embodiment, the elastomer may include a butyl rubber. For instance, the butyl rubber includes copolymers and terpolymers of isobutylene and at least one other comonomer. Useful comonomers include isoprene, divinyl aromatic monomers, alkyl substituted vinyl aromatic monomers, and mixtures thereof. Exemplary divinyl aromatic monomers include vinyl styrene. Exemplary alkyl substituted vinyl aromatic monomers include a-methyl styrene and paramethyl styrene. These copolymers and terpolymers may also be halogenated such as in the case of chlorinated and brominated butyl rubber. In one or more embodiments, these halogenated polymers may derive from monomers such as parabromomethylstyrene.

In one embodiment, the elastomer may comprise a multimodal copolymer rubber. For instance, such rubber can include: ethylene derived units; greater than about 50 wt. % and less than about 100 wt. % of a major polymer fraction having a Mooney viscosity of from about 15 ML (1+4@125° C.) to about 120 ML (1+4@125° C.), based on a total weight of the multimodal copolymer rubber; greater than about 0 wt. % and less than about 50 wt. % of a minor polymer fraction having a Mooney viscosity of from about 120 ML (1+4@125° C.) to about 1,500 ML (1+4@125° C.), based on the total weight of the multimodal copolymer rubber; an average molecular weight distribution (Mw/Mn) of from about 1.5 to about 4.5; and an average branching index factor (BI) of from about 0.7 and to about 1.0. The average polymer fractions could also be reverse (e.g., majority higher molecular weight and minority lower molecular weight). Accordingly, the multimodal copolymer rubber can have a relatively narrow molecular weight distribution and an overall Mooney viscosity of less than about 90 ML (1+4@ 125° C.), indicating that it can be easily processed and may require little or no extender oil. The multimodal copolymer rubber can almost be linear in structure, as indicated by its average branching index, and it can be completely amorphous or semi-crystalline in nature.

The multimodal copolymer rubber can include ethylene derived units, α-olefin derived units, and diene derived units, preferably non-conjugated diene derived units.

The α-olefin derived units can be or can include C2 to C20 α-olefins such as 1-butene, 1-hexene, 4-methyl-1-pentene, 1-octene, 1-decene, or combinations thereof. The α-olefin derived units are preferably propylene, 1-butene, 1-hexene, 1-octene, or combinations thereof, more preferably propylene. The non-conjugated diene derived units can be or can include 5-ethylidene-2-norbomene (ENB), 1,4-hexadiene, 1,6 octadiene, 5-methyl-1,4-hexadiene, 3,7-dimethyl-1,6-octadiene, dicyclopentadiene (DCPD), norbornadiene, 5-vinyl-2-norbomene (VNB), or combinations thereof. Examples of suitable ethylene-propylene-diene (EPDM) rubbers include Vistalon™ 5601, Vistalon™ 5702, Vistalon™ 7001, Vistalon™ 9301, etc. which are commercially available from ExxonMobil as well as Nordel™ grades, such as 4760, 4770, 4785, etc., from Dow, SABIC® EPDM756, and Keltan® grades, such as 8550C, 8570C, etc., from ARLANXEO.

The amount of ethylene derived units present in the multimodal copolymer rubber can range from about 45 wt. % to about 80 wt. %, preferably from about 50 wt. % to about 75 wt. %, and more preferably from about 55 wt. % to about 70 wt. %, based on a total weight of the rubber. The amount of diene derived units present in the TPV multimodal copolymer rubber can range from about 1 wt. % to about 10 wt. %, preferably from about 2 wt. % to about 8 wt. %, and more preferably from about 3 wt. % to about 6 wt. %, based on a total weight of the rubber. The α-olefin derived units can make up the remainder of the polymer units.

Ethylene content can be determined by FTIR, ASTM D3900, and is not corrected for diene content. ENB diene content can be determined by FTIR, ASTM D6047. Other dienes can be measured via ¾ NMR.

The multimodal copolymer rubber can be characterized by a multimodal molecular weight distribution, which can be simply referred to as multimodal molecular weight. In one or more embodiments, the multimodal copolymer rubber can include at least two fractions. The multimodality can manifest itself as two distinct peaks or a main peak and a shoulder peak in the MW GPC LALLS signal. This multimodality can be caused by the blending of a very high molecular weight component with a very low molecular weight component either as a result of sequential polymerization or by physical blending techniques. In this regard, the multimodal copolymer may be bimodal, trimodal, tetramodal, etc.

The multimodal copolymer rubber can include greater than about 50 wt. % and less than about 100 wt. %, preferably greater than about 55 wt. % and less than about 95 wt. %, and more preferably greater than about 60 wt. % and less than about 90 wt. %, of a major polymer fraction. The major polymer fraction can have a Mooney viscosity of from about 15 ML (1+4@125° C.) to about 120 ML (1+4@125° C.), preferably from about 25 ML (1+4@125° C.) to about 90 ML (1+4@125° C.), and more preferably from about 30 ML (1+4@125° C.) to about 80 ML (1+4@125° C.), based on a total weight of the multimodal copolymer rubber.

The multimodal copolymer rubber can include greater than about 0 wt. % and less than about 50 wt. %, preferably greater than about 5 wt. % and less than about 45 wt. %, and more preferably greater than about 10 wt. % and less than about 40 wt. %, of a minor polymer fraction. The minor polymer fraction can have a Mooney viscosity of from about 120 ML (1+4@125° C.) to about 1,500 ML (1+4@125° C.), preferably from about 120 ML (1+4@125° C.) to about 1,100 ML (1+4@125° C.), and more preferably from about 120 ML (1+4@125° C.) to about 700 ML (1+4@125° C.), based on a total weight of the multimodal copolymer rubber.

The multimodal copolymer rubber can have an overall Mooney viscosity of from about 20 ML (1+4@125° C.) to about 90 ML (1+4@125° C.), preferably from about 25 ML (1+4@125° C.) to about 85 ML (1+4@125° C.), and more preferably from about 30 ML (1+4@125° C.) to about 80 ML (1+4@125° C.). As used herein, Mooney viscosity is reported using the format: Rotor ([pre-heat time, min.]+ [shearing time, min.]@measurement temperature, ° C.), such that ML (1+4@125° C.) indicates a Mooney viscosity determined using the ML or large rotor according to ASTM D1646-99, for a pre-heat time of 1 minute and a shear time of 4 minutes, at a temperature of 125° C. Unless otherwise specified, Mooney viscosity is reported herein as ML (1+4@125° C.) in Mooney units according to ASTM D-1646. However, Mooney viscosity values greater than about 100 cannot generally be measured under these conditions. In this event, a higher temperature can be used (i.e., 150° C.), with eventual longer shearing times (i.e., 1+8@125° C. or 150° C.). More preferably, the Mooney measurement for purposes herein is carried out using a non-standard small rotor. The non-standard rotor design is employed with a change in the Mooney scale that allows the same instrumentation on the Mooney instrument to be used with polymers having a Mooney viscosity over about 100 ML (1+4@125° C.). For purposes herein, this modified Mooney determination is referred to as Mooney Small Thin (MST).

ASTM D 1646-99 prescribes the dimensions of the rotor to be used within the cavity of the Mooney instrument. This method allows for both a large and a small rotor, differing only in diameter. These different rotors are referred to in ASTM D 1646-99 as ML (Mooney Large) and MS (Mooney Small). However, EPDM rubbers can be produced at such high molecular weight that the torque limit of the Mooney instrument can be exceeded using these standard prescribed rotors. In these instances, the test is ran using the MST rotor that is both smaller in diameter and thinner. Typically, when the MST rotor is employed, the test is also run at different time constants and temperatures. The pre-heat time is changed from the standard 1 minute to 5 minutes, and the test is run at 200° C. instead of the standard 125° C. The value obtained under these modified conditions is referred to herein as MST (5+4@200° C.). Note: the run time of 4 minutes at the end of which the Mooney reading is taken remains the same as the standard conditions. One MST point is approximately equivalent to 5 ML points when MST is measured at (5+4@200° C.) and ML is measured at (1+4@125° C.). Accordingly, for the purposes of an approximate conversion between the two scales of measurement, the MST (5+4@200° C.) Mooney value is multiplied by 5 to obtain an approximate ML (1+4@125° C.) value equivalent. The MST rotor used herein has a diameter of 30.48+/−0.03 mm, a thickness of 2.8+/−0.03 mm (determined from the tops of serrations), and a shaft of 11 mm or less in diameter. The rotor has a serrated face and edge, with square grooves of about 0.8 mm width and depth of about 0.25-0.38 mm cut on 1.6 mm centers. The serrations will consist of two sets of grooves at right angles to each other thereby forming a square crosshatch. The rotor is positioned in the center of the die cavity such that the centerline of the rotor disk coincides with the centerline of the die cavity to within a tolerance of +/−0.25 mm. A spacer or a shim can be used to raise the shaft to the midpoint, consistent with practices typical in the art for Mooney determination. The wear point (cone shaped protuberance located at the center of the top face of the rotor) is machined off flat with the face of the rotor.

Mooney viscosities of the multimodal copolymer rubber can be determined on blends of polymers herein. The Mooney viscosity of a particular component of the blend is obtained herein using the relationship shown in equation (1): log ML=n_{A} log ML_{A}+NB log ML_{B} (1) wherein all logarithms are to the base 10; ML is the Mooney viscosity of a blend of two polymers A and B each having individual Mooney viscosities ML_{A} and ML_{B}, respectively; n_{A} represents the wt. % fraction of polymer A in the blend; and ne represents the wt. % fraction of the polymer B in the blend. Equation (1) can be used to determine the Mooney viscosity of blends comprising a high Mooney viscosity polymer (A) and a low Mooney viscosity polymer (B), which have measurable Mooney viscosities under (1+4@125° C.) conditions. Knowing ML, ML_{A} and n_{A} the value of ML_{B} can be calculated. However, for high Mooney viscosity polymers (i.e., Mooney viscosity greater than 100 ML (1+4@125° C.), ML_{A} can be measured using the MST rotor as described above. The Mooney viscosity of the low molecular weight polymer in the blend can then be determined using Equation 1 above, wherein ML_{A} is determined using the following correlation (2): ML_{A} (1+4@125° C.)=5.13*MST_{A} (5+4@200° C.) (2). In these or other embodiments, the Mooney viscosity of high molecular weight polymers can be determined by employing a Mooney viscometer model VR/1132 (Ueshima Seisakusho), which can measure Mooney viscosities up to 400 units.

The multimodal copolymer rubber can be made by polymerization using a metallocene catalyst. The resulting rubber can be in the form of particles having a particle size of from about 0.5 mm and to about 15.0 mm, preferably from about 1.0 mm to about 10.0 mm, and more preferably from about 1.5 mm to about 8.0 mm. As used herein, “particle size” refers to the weight-average particle size. These particles can be dusted with, for example, more than about 0.1 phr to prevent the rubber particles from sticking together. Such particulates can include, for example polyethylene dust particulates, in-organic filler materials such as calcium carbonate, talc, clay etc.

In one or more embodiments, the butyl rubber includes copolymers of isobutylene and isoprene, copolymers of isobutylene and paramethyl styrene, terpolymers of isobutylene, isoprene, and divinyl styrene, branched butyl rubber, and brominated copolymers of isobutene and paramethylstyrene (yielding copolymers with parabromomethylstyrenyl mer units). These copolymers and terpolymers may be halogenated. Furthermore, butyl rubbers may be prepared by polymerization, using techniques known in the art such as at a low temperature in the presence of a Friedel-Crafts catalyst.

In one embodiment, where the butyl rubber includes the isobutylene-isoprene copolymer, the copolymer may include from about 0.5 to about 30, or from about 0.8 to about 5, percent by weight isoprene based on the entire weight of the copolymer with the remainder being isobutylene.

In another embodiment, where the butyl rubber includes isobutylene-paramethyl styrene copolymer, the copolymer may include from about 0.5 to about 25, and from about 2 to about 20, percent by weight paramethyl styrene based on the entire weight of the copolymer with the remainder being isobutylene. In one embodiment, isobutylene-paramethyl styrene copolymers can be halogenated, such as with bromine, and these halogenated copolymers can contain from about 0 to about 10 percent by weight, or from about 0.3 to about 7 percent by weight halogenation.

In other embodiments, where the butyl rubber includes isobutylene-isoprene-divinyl styrene, the terpolymer may include from about 95 to about 99, or from about 96 to about 98.5, percent by weight isobutylene, and from about 0.5 to about 5, or from about 0.8 to about 2.5, percent by weight isoprene based on the entire weight of the terpolymer, with the balance being divinyl styrene.

In the case of halogenated butyl rubbers, the butyl rubber may include from about 0.1 to about 10, or from about 0.3 to about 7, or from about 0.5 to about 3 percent by weight halogen based upon the entire weight of the copolymer or terpolymer.

In one or more embodiments, the glass transition temperature (Tg) of the butyl rubber can be less than about −55° C., or less than about −58° C., or less than about −60° C., or less than about −63° C. Also, the Mooney viscosity (ML₁₊₈@125° C.) of the butyl rubber can be from about 25 to about 75, or from about 30 to about 60, or from about 40 to about 55.

Regarding the materials utilized in forming these elastomers, it should be understood that in certain embodiments, they may include bio-renewable monomers and/or recycled monomers. For instance, at least some of the monomers may include such bio-renewable monomers and/or recycled monomers. In one embodiment, all of the monomers utilized in making the elastomer may be bio-renewable monomers and/or recycled monomers. As one example, bioethanol can be a renewable source for the production of ethylene and/or propylene, which can be utilized to form the polyolefin elastomer copolymer as defined herein.

In general, the elastomer, in particular the polyolefin elastomer copolymer, may have a Mw of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more. The Mw may be about 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less. Furthermore, the elastomer, in particular the polyolefin elastomer copolymer, may have a Mn of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more. The Mn may be about 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less. In general, the molecular weight may be characterized by GPC (gel permeation chromatography) using polystyrene standards.

The thermoplastic vulcanizate and/or formulation may generally comprise about 2 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 40 wt. % or more, such as about 50 wt. % or more of the elastomer. The thermoplastic vulcanizate and/or formulation may comprise about 90 wt. % or less, such as about 80 wt. % or less, such as about 70 wt. % or less, such as about 60 wt. % or less, such as about 50 wt. % or less, such as about 40 wt. % or less, such as about 35 wt. % or less, such as about 30 wt. % or less, such as about 25 wt. % or less, such as about 20 wt. % or less, such as about 15 wt. % or less of the elastomer. In another embodiment, such aforementioned weight percentages may be based on the combined weight of the thermoplastic resin and the elastomer combined in the thermoplastic vulcanizate.

Furthermore, when a mixture of elastomers is present, the primary elastomer may be present in an amount of about 60 wt. % or more, such as about 70 wt. % or more, such as about 80 wt. % or more, such as about 90 wt. % or more to less than 100 wt. % based on the weight of the elastomer. The secondary elastomer may be present in an amount of 40 wt. % or less, such as 30 wt. % or less, such as 20 wt. % or less, such as 15 wt. % or less, such as 10 wt. % or less, such as 5 wt. % or more to more than 0 wt. % of the elastomer.

### C. Curing Composition

As indicated herein, the TPV formulation, in particular the elastomer within the formulation, can undergo dynamic vulcanization wherein the elastomer is at least partially cured. In general, any curing agent that is capable of curing or crosslinking the elastomer may be used. Some non-limiting examples of these curing agents include phenolic resins, peroxides, maleimides, and silicon-containing curing agents. The curing agents may be used with one or more coagents that serve as initiators, catalysts, etc. for purposes of improving the overall cure state of the elastomer. For instance, the curing composition of some embodiments includes one or both of zinc oxide (ZnO) and stannous chloride (SnCl₂).

In general, the phenolic resins may not necessarily be limited. For instance, these may include resole resins made by the condensation of alkyl substituted phenols or unsubstituted phenols with aldehydes, which can be formaldehydes, in an alkaline medium or by condensation of bi-functional phenoldialcohols. The alkyl substituents of the alkyl substituted phenols typically contain 1 to about 10 carbon atoms. Dimethylol phenols or phenolic resins, substituted in para-positions with alkyl groups containing 1 to about 10 carbon atoms can be used. These phenolic curing agents may be thermosetting resins and may be referred to as phenolic resin curing agents or phenolic resins. These phenolic resins may be ideally used in conjunction with a catalyst system. For example, non-halogenated phenol curing resins are used in conjunction with halogen donors and, optionally, a hydrogen halide scavenger. Where the phenolic curing resin is halogenated, a halogen donor is not required but the use of a hydrogen halide scavenger, such as ZnO, can be used.

Peroxide curing agents are generally selected from organic peroxides. Examples of organic peroxides include, but are not limited to, di-tert-butyl peroxide, dicumyl peroxide, t-butylcumyl peroxide, alpha, alpha-bis(tert-butylperoxy)diisopropyl benzene, 2,5 dimethyl 2,5-di(t-butylperoxy) hexane, 1,1-di(t-butylperoxy)-3,3,5-trimethyl cyclohexane, benzoyl peroxide, lauroyl peroxide, dilauroyl peroxide, 2,5-dimethyl-2,5-di(tert-butylperoxy) hexyne-3, and mixtures thereof. Also, diaryl peroxides, ketone peroxides, peroxydicarbonates, peroxyesters, dialkyl peroxides, hydroperoxides, peroxyketals and mixtures thereof may be used.

The silicon-containing curing agents generally include silicon hydride compounds having at least two SiH groups. These compounds react with carbon-carbon double bonds of unsaturated polymers in the presence of a hydrosilylation catalyst. Silicon hydride compounds include, but are not limited to, methylhydrogen polysiloxanes, methylhydrogen dimethyl-siloxane copolymers, alkyl methyl polysiloxanes, bis(dimethylsilyl)alkanes, bis(dimethylsilyl)benzene, and mixtures thereof.

As noted above, hydrosilylation curing may be conducted in the presence of a catalyst. These catalysts can include, but are not limited to, peroxide catalysts and catalysts including transition metals of Group VIII. These metals include, but are not limited to, palladium, rhodium, and platinum, as well as complexes of these metals.

In certain embodiments, the curing composition also includes one or both of ZnO and SnCl₂. In one embodiment, the curing composition may include zinc oxide. In another embodiment, the curing composition may include stannous chloride. In a further embodiment, the curing composition may include zinc oxide and stannous chloride.

Coagents may also be employed with the curing agents, such as the phenolic resin and/or peroxides. The coagent may include a multi-functional acrylate ester, a multi-functional methacrylate ester, or combination thereof. In other words, the coagents include two or more organic acrylate or methacrylate substituents. Examples of multi-functional acrylates include diethylene glycol diacrylate, trimethylolpropane triacrylate (TMPTA), ethoxylated trimethylolpropane triacrylate, propoxylated trimethylolpropane triacrylate, propoxylated glycerol triacrylate, pentaerythritol triacrylate, bistrimethylolpropane tetraacrylate, pentaerythritol tetraacrylate, ethoxylated pentaerythritol tetraacrylate, ethoxylated pentaerythritol triacrylate, cyclohexane dimethanol diacrylate, ditrimethylolpropane tetraacrylate, or combinations thereof. Examples of multi-functional methacrylates include trimethylol propane trimethacrylate (TMPTMA), ethylene glycol dimethacrylate, butanediol dimethacrylate, butylene glycol dimethacrylate, diethylene glycol dimethacrylate, polyethylene glycol dimethacrylate, allyl methacrylate, or combinations thereof. The coagent may also include triallylcyanurate, triallyl isocyanurate, triallyl phosphate, sulfur, N-phenyl-bis-maleamide, zinc diacrylate, zinc dimethacrylate, divinyl benzene, 1,2-polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, oximer for e.g., quinone dioxime, and the like.

Furthermore, an oil can be employed in the cure system. The oil may also be referred to as a process oil, an extender oil, or plasticizer. Useful oils include mineral oils, synthetic processing oils, or combinations thereof and may act as plasticizers. The plasticizers include, but are not limited to, aromatic, naphthenic, and extender oils. Exemplary synthetic processing oils include low molecular weight polylinear alpha-olefins, and polybranched alpha-olefins. Suitable esters include monomeric and oligomeric materials having an average molecular weight below about 2,000 g/mole, or below about 600 g/mole. Specific examples include aliphatic mono- or diesters or alternatively oligomeric aliphatic esters or alkyl ether esters.

The curing composition may be added in one or more locations, including the feed hopper of a melt mixing extruder. In some embodiments, the curing agent and any additional coagents may be added to the TPV formulation together; in other embodiments, one or more coagents may be added to the TPV formulation at different times from any one or more of the curing agents, as the TPV formulation is undergoing processing to form a TPV.

In general, the amount of curing agent present should be sufficient to at least partially vulcanize the elastomer and in some embodiments, to completely vulcanize the elastomer. For instance, the curing composition may be present in an amount of 1 phr or more, such as 2 phr or more, such as 3 phr or more, such as 5 phr or more, such as 8 phr or more, such as 10 phr or more, such as 12 phr or more, such as 14 phr or more, such as 16 phr or more, such as 18 phr or more, such as 20 phr or more. The curing composition may be present in an amount of 40 phr or less, such as 35 phr or less, such as 30 phr or less, such as 28 phr or less, such as 25 phr or less, such as 23 phr or less, such as 21 phr or less, such as 20 phr or less, such as 18 phr or less, such as 16 phr or less, such as 14 phr or less, such as 12 phr or less, such as 10 phr or less. Similarly, the curing agent may be present in an amount of 1 phr or more, such as 2 phr or more, such as 3 phr or more, such as 5 phr or more, such as 8 phr or more, such as 10 phr or more, such as 12 phr or more, such as 14 phr or more, such as 16 phr or more, such as 18 phr or more, such as 20 phr or more. The curing agent may be present in an amount of 40 phr or less, such as 35 phr or less, such as 30 phr or less, such as 28 phr or less, such as 25 phr or less, such as 23 phr or less, such as 21 phr or less, such as 20 phr or less, such as 18 phr or less, such as 16 phr or less, such as 14 phr or less, such as 12 phr or less, such as 10 phr or less.

### D. Oil

The thermoplastic vulcanizate and formulation as disclosed herein also comprise an oil. For instance, the oil includes, but is not limited to, a plasticizer oil, a process oil, an extender oil, or a mixture thereof, and the like. In this regard, the resulting thermoplastic vulcanizate may also comprise one or more of such oils.

Furthermore, as indicated herein, the oil comprises a re-refined oil. As utilized herein, “re-refined oil” refers to used or waste oil that has gone through a process similar to the original process of preparing crude oil for use (e.g., filtration, distillation, and/or dehydration, etc.). As examples, the “re-refined oil” may be obtained from the waste oil of an automobile garage during car service and/or from metal cutting industries who use oil during their process. During such refining process generally, contaminants can be removed. Re-refined oils may also include those re-refined oils based on any other oils disclosed below.

In this regard, in one embodiment, at least 85 wt. %, such as at least 90 wt. %, such as at least 93 wt. %, such as at least 95 wt. %, such as at least 97 wt. %, such as at least 98 wt. %, such as at least 99 wt. % of the re-refined may be the oil. For instance, the balance may be a contaminant. In this regard, less than 10 wt. %, such as less than 8 wt. %, such as less than 6 wt. %, such as less than 5 wt. %, such as less than 4 wt. %, such as less than 3 wt. %, such as less than 2 wt. %, such as less than 1 wt. % of the re-refined oil may be contaminants.

Particularly, the re-refined oil may have a sulfur content of 1000 ppm or less, such as 800 ppm or less, such as 600 ppm or less, such as 500 ppm or less, such as 400 ppm or less, such as 300 ppm or less, such as 200 ppm or less, such as 150 ppm or less, such as 100 ppm or less, such as 80 ppm or less, such as 50 ppm or less, such as 30 ppm or less, such as 20 ppm or less, such as 10 ppm or less. The sulfur content may be determined in accordance with ASTM D5185.

Also, the re-refined oil may have a polycyclic aromatics content of 5 wt. % or less, such as 4.5 wt. % or less, such as 4 wt. % or less, such as 3.5 wt. % or less, such as 3 wt. % or less, such as 2.5 wt. % or less, such as 2 wt. % or less, such as 1.5 wt. % or less, such as 1 wt. % or less. The polycyclic aromatics content may be determined in accordance with IP 346.

In addition, the re-refined oil may include 80 wt. % or more, such as 85 wt. % or more, such as 90 wt. % or more, such as 92 wt. % or more, such as 94 wt. % or more, such as 95 wt. % or more, such as 96 wt. % or more, such as 97 wt. % or more, such as 98 wt. % or more, such as 99 wt. % or more of saturates.

The purity of the re-refined oil may also be indicated by the color as determined in accordance with ASTM D1500. For instance, the re-refined oil may have a color value of 2 or less, such as 1.5 or less, such as 1.0 or less, such as 0.5 or less.

In certain embodiments, in addition to the re-refined oil, the oil may also comprise a virgin oil. In this regard, a virgin oil may be an oil not considered to be a re-refined oil. For instance, such oil may not be considered a waste or used oil that has been re-refined. Accordingly, in one embodiment, the oil may comprise a mixture of a re-refined oil and a virgin oil.

Any suitable oil may be included in some embodiments. In particular embodiments, oils may be selected from: (i) extension oil, that is, oil present in an oil-extended rubber (such as oil present with the elastomer); (ii) free oil, that is, oil that is added during the vulcanization process (separately from any other TPV formulation component such as the elastomer and thermoplastic vulcanizate); (iii) curative oil, that is, oil that is used to dissolve/disperse the curing agents, for example, a curative-in-oil dispersion such as a phenolic resin-in-oil (and in such embodiments, the curing composition may therefore be present in the TPV formulation as the curative-in-oil additive); and (iv) any combination of the foregoing oils from (i)-(iii). Thus, oil, such as re-refined oil, may be present in a TPV formulation as part of another component (e.g., as part of the elastomer when the process oil is an extension oil, such that the elastomer comprises elastomer and extension oil; or as part of the curing composition when the process oil is the carrier of a curative-in-oil, such that the curing composition comprises the curative oil and a curing agent). On the other hand, oil may be added to the TPV separately from other components, i.e., as free oil.

In one embodiment, the re-refined oil may be provided separately from any other component in the formulation. In another embodiment, the re-refined oil may be an extension oil such that it is provided with the elastomer. In this regard, such elastomer may be an oil extended elastomer, in particular a re-refined oil extended elastomer.

The extension oil, free oil, and/or curative oil may be the same or different oils in various embodiments. Process oils may include one or more of (i) “refined” or “mineral” oils, and (ii) synthetic oils. As used herein, mineral oils refer to any hydrocarbon liquid of lubricating viscosity (i.e., a kinematic viscosity at 100° C. of 1 mm²/sec or more) derived from petroleum crude oil and subjected to one or more refining and/or hydroprocessing steps (such as fractionation, hydrocracking, dewaxing, isomerization, and hydrofinishing) to purify and chemically modify the components to achieve a final set of properties. Such “refined” oils are in contrast to “synthetic” oils, which are manufactured by combining monomer units into larger molecules using catalysts, initiators, and/or heat.

In general, either refined or synthetic process oils according to some embodiments may include, but are not limited to, any one or more of aromatic, naphthenic, and paraffinic oils. Exemplary synthetic processing oils are polylinear alpha-olefins, polybranched alpha-olefins, and hydrogenated polyalphaolefins. The compositions of some embodiments of this invention may include organic esters, alkyl ethers, or combinations thereof.

In certain embodiments, at least a portion of the oil (e.g., all or a portion of any one or more of extension oil, free oil, and/or curative oil) is a low aromatic/sulfur content oil and has (i) an aromatic content of less than 5 wt. %, or less than 3.5 wt. %, or less than 1.5 wt. %, based on the weight of that portion of the oil; and (ii) a sulfur content of less than 0.3 wt. %, or less than 0.003 wt. %, based on the weight of that portion of the oil. Aromatic content may be determined in a manner consistent with method ASTM D2007. The percentage of aromatic carbon in the process oil of some embodiments is preferably less than 2, 1, or 0.5%. In certain embodiments, there are no aromatic carbons in the process oil. The proportion of aromatic carbon (%) as used herein is the proportion (percentage) of the number of aromatic carbon atoms to the number of all carbon atoms determined by the method in accordance with ASTM D2140.

Suitable oils of particular embodiments may include API Group I, II, III, IV, and V base oils. See API 1509, Engine Oil Licensing and Certification System, 17th Ed., September 2012, Appx. E, incorporated herein by reference. In this regard, in one embodiment, the oil may be a re-refined base oil, such as an API Group I, II, III, IV, and/or V base oil.

The oil may have a particular viscosity index as determined in accordance with ASTM D2270. For instance, the viscosity index may be 80 or more, such as 85 or more, such as 90 or more, such as 95 or more, such as 100 or more, such as 105 or more, such as 110 or more, such as 115 or more. The viscosity index may be 180 or less, such as 170 or less, such as 160 or less, such as 150 or less, such as 140 or less, such as 130 or less, such as 125 or less, such as 120 or less, such as 115 or less, such as 110 or less.

Aside from the viscosity index, the re-refined oil may have a particular kinematic viscosity as determined in accordance with ASTM D7279. For instance, at 40° C., the kinematic viscosity may be 15 cSt or more, such as 18 cSt or more, such as 21 cSt or more, such as 24 cSt or more, such as 27 cSt or more, such as 30 cSt. The kinematic viscosity at 40° C. may be 70 cSt or less, such as 60 cSt or less, such as 50 cSt or less, such as 45 cSt or less, such as 42 cSt or less, such as 39 cSt or less, such as 36 cSt or less, such as 33 cSt or less, such as 30 cSt or less, such as 27 cSt or less, such as 24 cSt or less. The kinematic viscosity at 100° C. may be 0.5 cSt or more, such as 1 cSt or more, such as 1.5 cSt or more, such as 2 cSt or more, such as 2.3 cSt or more, such as 2.6 cSt or more, such as 2.9 cSt or more, such as 3.3 cSt or more, such as 3.6 cSt or more, such as 3.9 cSt or more, such as 4.2 cSt or more, such as 4.6 cSt or more, such as 5 cSt or more. The kinematic viscosity at 100° C. may be 12 cSt or less, such as 10 cSt or less, such as 8 cSt or less, such as 7.6 cSt or less, such as 7.2 cSt or less, such as 6.8 cSt or less, such as 6.4 cSt or less, such as 6 cSt or less, such as 5.6 cSt or less, such as 5.2 cSt or less, such as 4.8 cSt or less, such as 4.4 cSt or less, such as 4 cSt or less.

Also, the re-refined oil may have a particular pour point as determined in accordance with ASTM D5949. For instance, the pour point may be 15° C. or less, such as 10° C. or less, such as 5° C. or less, such as 0° C. or less, such as −2° C. or less, such as −5° C. or less, such as −8° C. or less, such as −10° C. or less, such as −12° C. or less, such as −15° C. or less, such as −18° C. or less, such as −20° C. or less, such as −25° C. or less. The pour point may be −60° C. or more, such as −50° C. or more, such as −40° C. or more, such as −30° C. or more, such as −26° C. or more, such as −22° C. or more, such as −20° C. or more, such as −16° C. or more, such as −12° C. or more, such as −9° C. or more, such as −6° C. or more.

The oil, such as the re-refined oil, may be present in the formulation and/or thermoplastic vulcanizate in an amount of 10 phr or more, such as 20 phr or more, such as 30 phr or more, such as 40 phr or more, such as 50 phr or more, such as 60 phr or more, such as 70 phr or more, such as 80 phr or more, such as 90 phr or more, such as 100 phr or more, such as 110 phr or more, such as 120 phr or more, such as 130 phr or more. The oil, such as the re-refined oil, may be present in the formulation and/or thermoplastic vulcanizate in an amount of 250 phr or less, such as 220 phr or less, such as 200 phr or less, such as 180 phr or less, such as 160 phr or less, such as 150 phr or less, such as 140 phr or less, such as 130 phr or less, such as 120 phr or less, such as 110 phr or less, such as 100 phr or less.

The thermoplastic vulcanizate and/or formulation can generally comprise about 2 wt. % or more, such as about 5 wt. % or more, such as about 10 wt. % or more, such as about 15 wt. % or more, such as about 20 wt. % or more, such as about 25 wt. % or more, such as about 30 wt. % or more of the oil, such as the re-refined oil. The thermoplastic vulcanizate and/or formulation may comprise about 60 wt. % or less, about 50 wt. % or less, such as about 40 wt. % or less, such as about 35 wt. % or less, such as about 30 wt. % or less, such as about 25 wt. % or less, such as about 20 wt. % or less, such as about 15 wt. % or less of the oil, such as the re-refined oil.

Of the total oil provided, a majority of such oil may be provided as a free oil in one embodiment. For instance, 50 wt. % or more, such as 60 wt. % or more, 70 wt. % or more, such as 75 wt. % or more, such as 80 wt. % or more, such as 85 wt. % or more, such as 90 wt. % or more, such as 95 wt. % or more of the oil may be a free oil. The remaining oil may be an extension oil and/or a curative oil. For instance, 50 wt. % or less, such as 40 wt. % or less, such as 30 wt. % or less, such as 20 wt. % or less, such as 15 wt. % or less, such as 10 wt. % or less, such as 8 wt. % or less, such as 5 wt. % or less of the oil may be an extension oil and/or a curative oil.

Furthermore, in one embodiment, the re-refined oil may be primarily provided as a free oil rather than an extension oil and/or a curative oil. For instance, of the re-refined oil provided, 50 wt. % or more, such as 60 wt. % or more, 70 wt. % or more, such as 75 wt. % or more, such as 80 wt. % or more, such as 85 wt. % or more, such as 90 wt. % or more, such as 95 wt. % or more, such as 98 wt. % or more, such as about 100 wt. % may be provided as a free oil. The remaining oil may be an extension oil and/or a curative oil.

In another embodiment, the re-refined oil may be primarily provided as an extension oil rather than a free oil and/or a curative oil. For instance, of the re-refined oil provided, 50 wt. % or more, such as 60 wt. % or more, 70 wt. % or more, such as 75 wt. % or more, such as 80 wt. % or more, such as 85 wt. % or more, such as 90 wt. % or more, such as 95 wt. % or more, such as 98 wt. % or more, such as about 100 wt. % may be provided as an extension oil. The remaining oil may be a free oil and/or a curative oil.

### E. Other Additives

The thermoplastic vulcanizate formulation of some embodiments may optionally further comprise one or more additives. Suitable additional TPV additives include, but are not limited to, fillers (e.g., organic fillers, inorganic fillers, minerals, etc.), processing aids, acid scavengers, antioxidants, stabilizers, lubricants, antiblocking agents, anti-static agents, waxes, foaming agents, colorants/pigments, flame retardants and other processing aids and/or the like. In this regard, the resulting thermoplastic vulcanizate may also comprise one or more of such additives.

A TPV formulation of some embodiments may include a polymeric processing additive. The processing additive employed in such embodiments is a polymeric resin that has a very high melt flow index. These polymeric resins include both linear and branched molecules that have a melt flow rate that is greater than about 500 dg/min, more preferably greater than about 750 dg/min, even more preferably greater than about 1000 dg/min, still more preferably greater than about 1200 dg/min, and still more preferably greater than about 1500 dg/min. The thermoplastic elastomers of the present disclosure may include mixtures of various branched or various linear polymeric processing additives, as well as mixtures of both linear and branched polymeric processing additives. Reference to polymeric processing additives will include both linear and branched additives unless otherwise specified. The preferred linear polymeric processing additives are polypropylene homopolymers. The preferred branched polymeric processing additives include diene-modified polypropylene polymers.

In addition, the formulation may also include reinforcing and/or non-reinforcing fillers. Fillers and extenders that can be utilized include conventional inorganics such as calcium carbonate, clays, silica, talc, titanium dioxide, as well as organic, such as carbon block, graphene, and organic and inorganic nanoscopic fillers. In one embodiment, such filler may be a glass filler, such as glass fibers, glass beads, mixtures thereof, etc. In one embodiment, the formulation and resulting thermoplastic vulcanizate may not include any glass beads, in particular any glass beads. In this regard, such glass beads may be present in an amount of less than 1 wt. %, such as less than 0.5 wt. %, such as less than 0.3 wt. %, such as less than 0.1 wt. %, such as less than 0.05 wt. %, such as less than 0.01 wt. %, such as about 0 wt. % based on the weight of the thermoplastic vulcanizate.

In certain embodiments, the TPV formulation may include acid scavengers. These acid scavengers may be added to the thermoplastic vulcanizate after the desired level of cure has been achieved. Preferably, the acid scavengers are added after dynamic vulcanization. Useful acid scavengers include hydrotalcites. Both synthetic and natural hydrotalcites can be used. An exemplary natural hydrotalcite can be represented by the formula Mg₆Al₂ (OH)₁₆CO₃·4H₂O. Synthetic hydrotalcite compounds may have formula Mg_{4.3}Al₂ (OH)₁₂·6CO₃·mH₂O or Mg_{4.5}Al₂ (OH) 13CO₃·3.5H₂O.

These additives can be utilized in an amount to provide the desired effect. In this regard, the additives may be present in an amount of up to about 50 weight percent of the total TPV formulation or TPV. In this regard, a respective additive and/or combination of additives may be present in an amount of 0.001 wt. % or more, such as 0.01 wt. % or more, such as 0.05 wt. % or more, such as 0.1 wt. % or more, such as 0.2 wt. % or more, such as 0.3 wt. % or more, such as 0.5 wt. % or more, such as 1 wt. % or more, such as 2 wt. % or more, such as 3 wt. % or more, such as 5 wt. % or more, such as 8 wt. % or more, such as 10 wt. % or more, such as 12 wt. % or more, such as 15 wt. % or more, such as 20 wt. % or more, such as 25 wt. % or more, such as 30 wt. % or more. They may be present in an amount of 50 wt. % or less, such as 40 wt. % or less, such as 30 wt. % or less, such as 25 wt. % or less, such as 20 wt. % or less, such as 18 wt. % or less, such as 15 wt. % or less, such as 13 wt. % or less, such as 10 wt. % or less, such as 8 wt. % or less, such as 6 wt. % or less, such as 4 wt. % or less, such as 3 wt. % or less, such as 2 wt. % or less, such as 1 wt. % or less, such as 0.5 wt. % or less. In another embodiment, such aforementioned percentages may be based on the weight of the thermoplastic resin. In a further embodiment, such aforementioned percentages may be based on the weight of the elastomer. In an even further embodiment, such aforementioned percentages may be based on the combined weight of the thermoplastic resin and elastomer.

### F. TPV Formulation

In general, as used herein, a “TPV formulation” refers to the mixture of ingredients blended or otherwise compiled before or during processing of the TPV formulation in order to form a TPV. This is in recognition of the fact that the ingredients that are mixed together and then processed may or may not be present in the final TPV in the same amounts added to the formulation, depending upon the reactions that take place among some or all of the ingredients during processing of the mixed ingredients.

In general, a TPV formulation according to various embodiments includes the elastomer, thermoplastic resin, curing agent (or curing composition), and oil including a re-refined oil along with any other optional additives. As will be discussed in more detail below, the TPV formulation undergoes processing, including dynamic vulcanization or dynamic curing, to form a TPV. In certain embodiments, any other additives may be added to the TPV formulation during processing, either before or after dynamic vulcanization.

Relative amounts of the various components in TPV formulations are conveniently characterized based upon the amount of elastomer in the formulation, in particular in parts by weight per hundred parts by weight of rubber (phr). In embodiments wherein the elastomer comprises both elastomer with an extension oil, as is common for much commercially available elastomers such as EPDM, the phr amounts are based only upon the amount of elastomer, exclusive of extension oil present with the elastomer. Thus, as an example, an elastomer containing 100 parts EPDM (rubber) and 75 parts extension oil would in fact be considered present in a TPV formulation at 175 phr (i.e., on the basis of the 100 parts EPDM rubber). If such a TPV formulation were further characterized as containing 50 phr thermoplastic resin, the formulation would include 50 parts by weight of thermoplastic resin in addition to the 100 parts by weight elastomer and 75 parts by weight extension oil.

TPV formulations of some embodiments may include the thermoplastic resin in an amount from about 10 to about 300 parts per hundred parts by weight of the elastomer or rubber (phr). In various embodiments, the thermoplastic resin is included in a TPV formulation in an amount ranging from a low of any one of about 10, 15, 20, 25, 30, 35, 40, 45, 50, 55, 60, 65, 70, 75, 80, 85, 90, 95, 100, 105, 110, 115, 120, 125, 130, 135, 140, 145, 150, 165, 170, and 175 phr, to a high of any one of about 100, 125, 150, 175, 200, 225, 250, 275, 300, 350, 400, 450, 500, 550, 600, 650, 700, 750 phr. The thermoplastic resin may be included in an amount ranging from any of the aforementioned lows to any of the aforementioned highs, provided that the high value is greater than or equal to the low value. In particular embodiments, increasing amounts of thermoplastic resin correspond to increasing hardness of the dynamically vulcanized TPV.

When the elastomer consists of elastomer only, it is by definition present at 100 phr (since it is the basis of the phr notation). However, in embodiments wherein the elastomer component comprises a constituent other than an elastomer, such as an extender oil, the elastomer may be included in a TPV formulation in an amount ranging from a low of any one of about 100.05, 100.1, 100.15, 100.2, 105, 110, 115, and 120 phr to a high of any one of about 110, 120, 125, 150, 175, 200, 225, and 250 phr.

As previously noted, TPV formulations of certain embodiments may optionally include additional TPV additives. Amounts of additional additive are separate and in addition to those additives already included in another component of a TPV formulation. For instance, any additive such as extension oil included with the elastomer has already been accounted for as part of the amount of elastomer added to the formulation; recited amounts of additional additives therefore are exclusive of additives already included with the elastomer. Additional additives may be present in a TPV formulation in the aggregate in an amount ranging from about 0 phr to about 300 phr. In certain embodiments, additional additives may in the aggregate be present in the TPV in an amount ranging from a low of any one of about 0, 5, 10, 15, 25, 30, 40, 50, 60, 70, 80, 90, and 100 phr, to a high of any one of about 25, 30, 40, 50, 60, 80, 100, 125, 150, 175, 200, 225, 250, 275, and 300 phr. The additional additives may be included in an aggregate amount ranging from any one of the aforementioned lows to any one of the aforementioned highs, provided that the high value is greater than or equal to the low value. In one embodiment, such aforementioned phr may refer to the additional additives individually rather than the aggregate.

For convenience, components of TPV formulations of various embodiments may alternatively be characterized based upon their weight percentages in the TPV formulation according to the following:

The thermoplastic resin(s) may be present in a TPV formulation in amounts ranging from a low of any one of about 5, 6, 7, 8, 9, 10, 11, 12, 13, 14, 15, 16, 17, 18, 19, 20, 21, 22, 23, 24, and 25 wt. % to a high of any one of about 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, and 60 wt. %, provided that the high is greater than or equal to the low.

The elastomer(s) may be present in a TPV formulation in amounts ranging from a low of any one of about 3, 4, 5, 6, 7, 8, 9, 10, 11, 12, 13, 14, 15, 16, 17, 18, 19, 20, 25, 30, and 35 wt. % to a high of any one of about 35, 40, 45, 50, 55, 60, 65, 70, 75, and 80 wt. %, provided that the high is greater than or equal to the low, and that the elastomeric(s) are present in the TPV formulation within the range of about 20 to about 300 phr.

The optional additional TPV additive(s) may be present in a TPV formulation in aggregate amounts ranging from a low of any one of about 0, 5, 10, 15, 20, 25, 30, 35, and 40 wt. % to a high of any one of about 30, 35, 40, 45, 50, 55, 60, and 65 wt. %, provided that the high is greater than or equal to the low, and that the additive(s) are present in the TPV formulation within the range of about 0 to about 300 phr.

As indicated herein, the thermoplastic vulcanizate as disclosed herein includes a relatively high level of recycled content. For instance, as the thermoplastic formulation and/or the thermoplastic vulcanizate include a re-refined oil as mentioned herein. In addition, the thermoplastic formulation and/or the thermoplastic vulcanizate may also include a recycled thermoplastic resin. Accordingly, the recycled content may include the re-refined oil and any recycled thermoplastic resin. In present, the recycled content may also include any recycled elastomer. Accordingly, the recycled content may be about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 50 wt. % or more, such as about 60 wt. % or more, such as about 70 wt. % or more, such as about 80 wt. % or more, such as about 90 wt. % or more based on the total weight of the thermoplastic formulation and/or thermoplastic vulcanizate. The recycled content may comprise about 95 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 30 wt. % or less, such as about 20 wt. % or less based on the total weight of the thermoplastic formulation and/or thermoplastic vulcanizate.

### G. Processing TPV Formulations

The thermoplastic vulcanizate of the present disclosure is prepared by dynamic vulcanization techniques. The term “dynamic vulcanization” refers to a vulcanization or curing process for a TPV formulation comprising an elastomer, wherein the elastomer is vulcanized under conditions of high shear mixing at a temperature above the melting point of the thermoplastic resin to produce a thermoplastic vulcanizate. In dynamic vulcanization, an elastomer is simultaneously crosslinked and dispersed as fine particles within the thermoplastic resin or matrix, although other morphologies, such as co-continuous morphologies, may exist depending on the degree of cure, the elastomer to resin viscosity ratio, the intensity of mixing, the residence time, and the temperature.

In this regard, the present disclosure is directed to a method of dynamically vulcanizing or dynamically curing a formulation comprising a thermoplastic resin, an elastomer, an oil comprising a re-refined oil, and a curing agent. Accordingly, the dynamic vulcanization occurs in the presence of the re-refined oil. Such method may in turn provide a thermoplastic vulcanizate comprising the thermoplastic resin and an at least partially cured elastomer. For instance, the thermoplastic resin may be provided as a continuous phase or matrix wherein the at least partially cured elastomer is provided as a dispersed phase within the continuous thermoplastic phase.

In some embodiments, processing may include melt blending, in a chamber, a TPV formulation comprising the elastomer, thermoplastic resin, and curing agent. The chamber may be any vessel that is suitable for blending the selected composition under temperature and shearing force conditions necessary to form a thermoplastic vulcanizate. In this respect, the chamber may be a mixer, such as Banbury™ mixers or Brabender™ mixers, and certain mixing extruders such as co-rotating, counter-rotating, and twin-screw extruders, as well as co-kneaders, such as Buss® kneaders. According to one embodiment, the chamber is an extruder, which may be a single or multi-screw extruder. The term “multi-screw extruder” means an extruder having two or more screws; with two and three screw extruders being exemplary, and two or twin screw extruders being preferred in some embodiments. The screws of the extruder may have a plurality of lobes; two and three lobe screws being preferred. It will readily be understood that other screw designs may be selected in accordance with the methods of embodiments of the present disclosure. In some embodiments, dynamic vulcanization may occur during and/or as a result of extrusion. After discharging from the mixer, the blend containing the vulcanized rubber and the thermoplastic can be milled, chopped, extruded, pelletized, injection-molded, or processed by any other desirable technique.

The dynamic vulcanization of the elastomer may be carried out to achieve relatively high shear. In particular embodiments, the blending may be performed at a temperature not exceeding about 400° C., preferably not exceeding about 300° C., and more preferably not exceeding about 250° C. The minimum temperature at which the melt blending is performed is generally higher than or equal to about 130° C., preferably higher than or equal to about 150° C. and more particularly higher than about 180° C. The blending time is chosen by taking into account the nature of the compounds used in the TPV formulation and the blending temperature. The time generally varies from about 5 seconds to about 120 minutes, and in most cases from about 10 seconds to about 30 minutes.

Dynamic vulcanization in some embodiments may include phase inversion. As those skilled in the art appreciate, dynamic vulcanization may begin by including a greater volume fraction of rubber than thermoplastic resin. As such, the thermoplastic resin may be present as the discontinuous phase when the rubber volume fraction is greater than that of the volume fraction of the thermoplastic resin. As dynamic vulcanization proceeds, the viscosity of the rubber increases and phase inversion occurs under dynamic mixing. In other words, upon phase inversion, the thermoplastic resin phase becomes the continuous phase.

Other additive(s) are preferably present within the TPV formulation when dynamic vulcanization is carried out, although in some embodiments, one or more other additives (if any) may be added to the composition after the curing and/or phase inversion (e.g., after the dynamic vulcanization portion of processing). The additional additives may be included after dynamic vulcanization by employing a variety of techniques. In one embodiment, they can be added while the thermoplastic vulcanizate remains in its molten state from the dynamic vulcanization process. For example, the additional additives can be added downstream of the location of dynamic vulcanization within a process that employs continuous processing equipment, such as a single or twin screw extruder. In other embodiments, the thermoplastic vulcanizate can be “worked-up” or pelletized, subsequently melted, and the additional additives can be added to the molten thermoplastic vulcanizate product. This latter process may be referred to as a “second pass” addition of the ingredients.

Despite the fact that the elastomer may be partially or fully cured, the thermoplastic vulcanizate can be processed and reprocessed by conventional plastic processing techniques such as extrusion, injection molding, and compression molding. The elastomer within these thermoplastic elastomers is usually in the form of finely-divided and well-dispersed particles of vulcanized or cured rubber within a continuous thermoplastic phase or matrix, although a co-continuous morphology or a phase inversion is also possible. In those embodiments where the cured rubber is in the form of finely-divided and well-dispersed particles within the thermoplastic medium, the rubber particles may have an average diameter that is less than 50 μm, such as less than 30 μm, such as less than 10 μm, such as less than 5 μm, such as less than 1 μm. In preferred embodiments, at least 50%, such as at least 60%, such as at least 75% of the rubber particles may have an average diameter of less than 5 μm, such as less than 2 μm, such as less than 1 μm.

The degree of cure can be measured by determining the amount of rubber that is extractable from the thermoplastic vulcanizate by using cyclohexane or boiling xylene as an extractant. Preferably, the rubber may have a degree of cure where not more than 15 weight percent, such as not more than 10 weight percent, such as not more than 5 weight percent, such as not more than 3 weight percent is extractable by cyclohexane at 23° C. as described in U.S. Pat. Nos. 4,311,628, 5,100,947 and 5,157,081, all of which are incorporated herein by reference. Alternatively, the rubber may have a degree of cure such that the crosslink density is at least 4×10⁻⁵, such as at least 7×10⁻⁵, such as at least 10×10⁻⁵ moles per milliliter of rubber. See Crosslink Densities and Phase Morphologies in Dynamically Vulcanized TPEs, by Ellul et al., Rubber Chemistry and Technology, Vol. 68, pp. 573-584 (1995).

The resulting thermoplastic vulcanizate may have the desired density that allows it to be utilized for a molded part as described herein. In this regard, the density may be 0.3 g/cm³ or more, such as 0.4 g/cm³ or more, such as 0.5 g/cm³ or more, such as 0.6 g/cm³ or more, such as 0.65 g/cm³ or more, such as 0.7 g/cm³ or more, such as 0.75 g/cm³ or more, such as 0.8 g/cm³ or more, such as 0.85 g/cm³ or more, such as 0.9 g/cm³ or more, such as 0.95 g/cm³ or more, such as 1 g/cm³ or more, such as 1.05 g/cm³ or more, such as 1.1 g/cm³ or more, such as 1.15 g/cm³ or more, such as 1.2 g/cm³ or more. The density may be 2 g/cm³ or less, such as 1.8 g/cm³ or less, such as 1.6 g/cm³ or less, such as 1.4 g/cm³ or less, such as 1.3 g/cm³ or less, such as 1.2 g/cm³ or less, such as 1.1 g/cm³ or less, such as 1.0 g/cm³ or less, such as 0.95 g/cm³ or less, such 0.90 g/cm³ or less, such as 0.7 g/cm³ or less, such as 0.6 g/cm³ or less, such as 0.55 g/cm³ or less.

### H. Formation of Molded Parts

Once formed, the thermoplastic vulcanizate may be shaped into the form of a molded part using any of a variety of techniques as is known in the art. For instance, the thermoplastic vulcanizate can advantageously be fabricated by employing typical molding processes, such as injection molding, extrusion molding, compression molding, blow molding, rotational molding, overmolding, etc. In general, these processes include heating the thermoplastic vulcanizate to a temperature that is equal to or in excess of the melt temperature of the thermoplastic resin to form a pre-form for a mold cavity to then form the molded part, cooling the molded part to a temperature at or below the crystallization temperature of the thermoplastic vulcanizate, and releasing the molded part from a mold. The mold cavity defines the shape of the molded part. The molded part is cooled within the mold at a temperature at or below the crystallization temperature of the thermoplastic vulcanizate and the molded part can subsequently be released from the mold.

The thermoplastic vulcanizate may also be shaped using extrusion molding to form the molded part. In this regard, the thermoplastic vulcanizate may be extruded as described herein. Upon exiting the extruder, the thermoplastic vulcanizate may be formed or shaped to form the molded part. Such molded part may be formed by using a particular die to shape the thermoplastic vulcanizate as it exits the extruder. Such shaping/forming process, such as the extrusion process, may be an automated or robotic process. In this regard, the method of forming a molded part is not necessarily limited.

### I. Properties

By utilizing a re-refined oil as disclosed herein, the thermoplastic vulcanizate may exhibit certain desired properties. For instance, utilizing materials as disclosed herein, such as the re-refined oil and optional other recycled materials such as the thermoplastic resin and elastomer, can result in a reduced carbon footprint. In particular, utilizing a cradle-to-gate approach, the carbon footprint may be 3.0 kgCO₂ eq/kg or lower, such as 2.8 kgCO₂ eq/kg or lower, such as 2.6 kgCO₂ eq/kg or lower, such as 2.4 kgCO₂ eq/kg or lower, such as 2.2 kgCO₂ eq/kg or lower, such as 2.0 kgCO₂ eq/kg or lower, such as 1.8 kgCO₂ eq/kg or lower, such as 1.6 kgCO₂ eq/kg or lower, such as 1.5 kgCO₂ eq/kg or lower, such as 1.4 kgCO₂ eq/kg or lower, such as 1.3 kgCO₂ eq/kg or lower, such as 1.2 kgCO₂ eq/kg or lower, such as 1.1 kgCO₂ eq/kg or lower, such as 1.0 kgCO₂ eq/kg or lower. The carbon footprint may be estimated using the following equation:

$${CO}_{2} Footprint = \sum {W}_{i} \cdot {X}_{i} + C$$

where Wᵢ is the weight fraction, Xᵢ is the CO₂ footprint of the component i in formulation, C is the constant that may be added to account for CO₂ emissions from energy use, raw material logistics, and packaging involved. In the present disclosure, C was estimated to be approximately 0.35 kgCO₂ eq/kg. The CO₂ footprint value of the base raw materials was derived from an EcoInvent 3.6 database or as supplied by a raw material manufacturer.

In addition, the present inventor has discovered that the properties of these materials utilizing recycled content may even be comparable to those exhibited by the same thermoplastic vulcanizate made from one or more virgin oils and not from any re-refined oil(s). In particular, any single respective property as identified below for a thermoplastic vulcanizate including a re-refined oil as defined herein may be within 35%, such as within 30%, such as within 25%, such as within 20%, such as within 18%, such as within 16%, such as within 14%, such as within 12%, such as within 10%, such as within 9%, such as within 8%, such as within 7%, such as within 6%, such as within 5%, such as within 4%, such as within 3%, such as within 2%, such as within 1% of a corresponding thermoplastic vulcanizate made from virgin oils and not from any re-refined oils.

In this regard, the thermoplastic vulcanizate may exhibit a particular Shore A hardness (ASTM 2240-15 (2021); 15 seconds), which is utilized to measure the hardness of the thermoplastic vulcanizate and provide an indication of the resistance to indentation. In this regard, the thermoplastic vulcanizate may have a Shore A hardness of from 25 to 100. For instance, the thermoplastic vulcanizate may have a Shore A hardness of 25 or more, such as 35 or more, such as 40 or more, such as 45 or more, such as 50 or more, such as 55 or more, such as 60 or more, such as 65 or more, such as 70 or more, such as 75 or more. The thermoplastic vulcanizate may have a Shore A hardness of 100 or less, such as 95 or less, such as 90 or less, such as 80 or less, such as 70 or less, such as 65 or less, such as 60 or less, such as 55 or less, such as 50 or less. Such hardness may allow for the thermoplastic resin and/or resulting molded part to provide the compliance necessary to effectively function for a desired application. In one embodiment, the aforementioned Shore A hardness may be for an unaged sample. In another embodiment, the aforementioned Shore A hardness may be for an aged sample. For instance, the sample may be aged in an oven for 168 hours at 70° C., 168 hours at 110° C., and/or 1000 hours at 100° C. In this regard, such Shore A hardness may be realized at least at one, such as at least at two, such as all three of the aforementioned aging conditions.

Relatedly, the thermoplastic vulcanizate may exhibit a particular Shore D hardness (ASTM 2240-15 (2021); 15 seconds) as well. In this regard, the thermoplastic vulcanizate may have a Shore D hardness of from greater than 0 to 50. For instance, the thermoplastic vulcanizate may have a Shore D hardness of more than 0, such as 5 or more, such as 10 or more, such as 15 or more, such as 20 or more, such as 25 or more, such as 30 or more, such as 35 or more, such as 40 or more. The thermoplastic vulcanizate may have a Shore D hardness of 50 or less, such as 45 or less, such as 40 or less, such as 35 or less, such as 30 or less, such as 25 or less, such as 20 or less, such as 15 or less, such as 10 or less, such as 5 or less. In one embodiment, the aforementioned Shore D hardness may be for an unaged sample. In another embodiment, the aforementioned Shore D hardness may be for an aged sample. For instance, the sample may be aged in an oven for 168 hours at 70° C., 168 hours at 110° C., and/or 1000 hours at 100° C. In this regard, such Shore D hardness may be realized at least at one, such as at least at two, such as all three of the aforementioned aging conditions.

In addition, the thermoplastic vulcanizate may exhibit a certain strength as indicated by certain mechanical properties. For instance, the thermoplastic vulcanizate may exhibit a 100% modulus (ASTM D412-16, Die C, across flow), also referred to as the modulus at 100% elongation or M100, of at least 0.3 MPa, such as from 0.3 to 50 MPa, such as from 0.5 to 10 MPa, such as from 1 to 8 MPa, such as from 2 to 7 MPa. For instance, the 100% modulus may be 0.3 MPa or more, such as 0.4 MPa or more, such as 0.5 MPa or more, such as 0.8 MPa or more, such as 1 MPa or more, such as 1.1 MPa or more, such as 1.2 MPa or more, such as 1.3 MPa or more, such as 1.4 MPa or more, such as 1.5 MPa or more, such as 2 MPa or more, such as 2.5 MPa or more, such as 3 MPa or more, such as 4 MPa or more, such as 5 MPa or more, such as 6 MPa or more, such as 10 MPa or more, such as 20 MPa or more, such as 30 MPa or more. The 100% modulus may be 50 MPa or less, such as 40 MPa or less, such as 30 MPa or less, such as 25 MPa or less, such as 20 MPa or less, such as 15 MPa or less, such as 10 MPa or less, such as 8 MPa or less, such as 6 MPa or less, such as 5 MPa or less, such as 4.5 MPa or less, such as 4 MPa or less, such as 3.8 MPa or less, such as 3.5 MPa or less, such as 3.3 MPa or less, such as 3 MPa or less, such as 2.8 MPa or less, such as 2.5 MPa or less, such as 2.3 MPa or less, such as 2 MPa or less, such as 1.9 MPa or less, such as 1.8 MPa or less, such as 1.5 MPa or less, such as 1.3 MPa or less, such as 1.1 MPa or less, such as 0.8 MPa or less. In one embodiment, the aforementioned modulus at 100% elongation may be for an unaged sample. In another embodiment, the aforementioned modulus at 100% elongation may be for an aged sample. For instance, the sample may be aged in an oven for 168 hours at 70° C., 168 hours at 110° C., and/or 1000 hours at 100° C. In this regard, such modulus at 100% elongation may be realized at least at one, such as at least at two, such as all three of the aforementioned aging conditions.

In addition, the thermoplastic vulcanizate may exhibit a certain strength as indicated by certain mechanical properties. For instance, the thermoplastic vulcanizate may exhibit a 50% modulus (ASTM D412-16, Die C, across flow), also referred to as the modulus at 50% elongation or M50, of at least 0.3 MPa, such as from 0.3 to 50 MPa, such as from 0.5 to 10 MPa, such as from 1 to 8 MPa, such as from 2 to 7 MPa. For instance, the 50% modulus may be 0.3 MPa or more, such as 0.4 MPa or more, such as 0.5 MPa or more, such as 0.8 MPa or more, such as 1 MPa or more, such as 1.1 MPa or more, such as 1.2 MPa or more, such as 1.3 MPa or more, such as 1.4 MPa or more, such as 1.5 MPa or more, such as 2 MPa or more, such as 2.5 MPa or more, such as 3 MPa or more, such as 4 MPa or more, such as 5 MPa or more, such as 6 MPa or more, such as 10 MPa or more, such as 20 MPa or more, such as 30 MPa or more. The 50% modulus may be 50 MPa or less, such as 40 MPa or less, such as 30 MPa or less, such as 25 MPa or less, such as 20 MPa or less, such as 15 MPa or less, such as 10 MPa or less, such as 8 MPa or less, such as 6 MPa or less, such as 5 MPa or less, such as 4.5 MPa or less, such as 4 MPa or less, such as 3.8 MPa or less, such as 3.5 MPa or less, such as 3.3 MPa or less, such as 3 MPa or less, such as 2.8 MPa or less, such as 2.5 MPa or less, such as 2.3 MPa or less, such as 2 MPa or less, such as 1.9 MPa or less, such as 1.8 MPa or less, such as 1.5 MPa or less, such as 1.3 MPa or less, such as 1.1 MPa or less, such as 0.8 MPa or less. In one embodiment, the aforementioned modulus at 50% elongation may be for an unaged sample. In another embodiment, the aforementioned modulus at 50% elongation may be for an aged sample. For instance, the sample may be aged in an oven for 168 hours at 70° C., 168 hours at 110° C., and/or 1000 hours at 100° C. In this regard, such modulus at 50% elongation may be realized at least at one, such as at least at two, such as all three of the aforementioned aging conditions.

In addition, the thermoplastic vulcanizate may exhibit a certain strength as indicated by certain mechanical properties. For instance, the thermoplastic vulcanizate may exhibit a 25% modulus (ASTM D412-16, Die C, across flow), also referred to as the modulus at 25% elongation or M25, of at least 0.3 MPa, such as from 0.3 to 50 MPa, such as from 0.5 to 10 MPa, such as from 1 to 8 MPa, such as from 1 to 4 MPa. For instance, the 25% modulus may be 0.3 MPa or more, such as 0.4 MPa or more, such as 0.5 MPa or more, such as 0.8 MPa or more, such as 1 MPa or more, such as 1.1 MPa or more, such as 1.2 MPa or more, such as 1.3 MPa or more, such as 1.4 MPa or more, such as 1.5 MPa or more, such as 2 MPa or more, such as 2.5 MPa or more, such as 3 MPa or more, such as 4 MPa or more, such as 5 MPa or more, such as 6 MPa or more, such as 10 MPa or more, such as 20 MPa or more, such as 30 MPa or more. The 25% modulus may be 50 MPa or less, such as 40 MPa or less, such as 30 MPa or less, such as 25 MPa or less, such as 20 MPa or less, such as 15 MPa or less, such as 10 MPa or less, such as 8 MPa or less, such as 6 MPa or less, such as 5 MPa or less, such as 4.5 MPa or less, such as 4 MPa or less, such as 3.8 MPa or less, such as 3.5 MPa or less, such as 3.3 MPa or less, such as 3 MPa or less, such as 2.8 MPa or less, such as 2.5 MPa or less, such as 2.3 MPa or less, such as 2 MPa or less, such as 1.9 MPa or less, such as 1.8 MPa or less, such as 1.5 MPa or less, such as 1.3 MPa or less, such as 1.1 MPa or less, such as 0.8 MPa or less. In one embodiment, the aforementioned modulus at 25% elongation may be for an unaged sample. In another embodiment, the aforementioned modulus at 25% elongation may be for an aged sample. For instance, the sample may be aged in an oven for 168 hours at 70° C., 168 hours at 110° C., and/or 1000 hours at 100° C. In this regard, such modulus at 25% elongation may be realized at least at one, such as at least at two, such as all three of the aforementioned aging conditions.

The thermoplastic vulcanizate may also exhibit a tensile stress at break (i.e., tensile strength) of from 0.5 to 50 MPa, such as from 1 to 20 MPa, such as from 2 to 12 MPa, such as from 3 to 9 MPa. For instance, the thermoplastic vulcanizate may exhibit a tensile stress of 0.5 MPa or more, such as 1 MPa or more, such as 1.5 MPa or more, such as 2 MPa or more, such as 2.5 MPa or more, such as 3 MPa or more, such as 3.5 MPa or more, such as 4 MPa or more, such as 4.5 or more, such as 5 MPa or more, such as 5.5 or more, such as 6 MPa or more, such as 7 MPa or more, such as 8 MPa or more, such as 9 MPa or more, such as 10 MPa or more, such as 15 MPa or more, such as 20 MPa or more, such as 30 MPa or more, such as 40 MPa or more, such as 50 MPa or more, such as 60 MPa or more, such as 70 MPa or more. The tensile stress may be 100 MPa or less, such as 80 MPa or less, such as 60 MPa or less, such as 50 MPa or less, such as 40 MPa or less, such as 30 MPa or less, such as 25 MPa or less, such as 20 MPa or less, such as 18 MPa or less, such as 15 MPa or less, such as 13 MPa or less, such as 11 MPa or less, such as 10 MPa or less, such as 9 MPa or less, such as 8 MPa or less, such as 7 MPa or less, such as 6.5 MPa or less, such as 6 MPa or less, such as 5.5 MPa or less, such as 5 MPa or less, such as 4.5 MPa or less, such as 4 MPa or less, such as 3.5 MPa or less, such as 3 MPa or less, such as 2.5 MPa or less. The tensile stress may be determined in accordance with ASTM D412-16 at a temperature of 23° C. (Die C, across flow). In one embodiment, the aforementioned tensile stress at break may be for an unaged sample. In another embodiment, the aforementioned tensile stress at break may be for an aged sample. For instance, the sample may be aged in an oven for 168 hours at 70° C., 168 hours at 110° C., and/or for 1000 hours at 100° C. In this regard, such tensile stress at break may be realized at least at one, such as at least at two, such as all three of the aforementioned aging conditions.

The thermoplastic vulcanizate may also exhibit a desired elongation at break. For instance, the elongation at break may be 20% or more, such as 40% or more, such as 60% or more, such as 80% or more, such as 100% or more, such as 150% or more, such as 200% or more, such as 250% or more, such as 300% or more, such as 350% or more, such as 400% or more, such as 500% or more, such as 550% or more, such as 600% or more, such as 650% or more, such as 700% or more, such as 750% or more, such as 900% or more. The elongation at break may be 2000% or less, such as 1800% or less, such as 1500% or less, such as 1300% or less, such as 1000% or less, such as 900% or less, such as 800% or less, such as 700% or less, such as 600% or less, such as 500% or less, such as 450% or less, such as 400% or less, such as 350% or less, such as 300% or less. The elongation at break may be determined in accordance with ASTM D412-16 at a temperature of 23° C. (Die C, across flow). In one embodiment, the aforementioned elongation at break may be for an unaged sample. In another embodiment, the aforementioned elongation at break may be for an aged sample. For instance, the sample may be aged in an oven for 168 hours at 70° C., 168 hours at 110° C., and/or 1000 hours at 100° C. In this regard, such elongation at break may be realized at least at one, such as at least at two, such as all three of the aforementioned aging conditions.

The thermoplastic vulcanizate may also be characterized by an advantageously low compression set. For instance, the compression set may be 85% or less, such as 80% or less, such as 70% or less, such as 65% or less, such as 60% or less, such as 55% or less, such as 50% or less, such as 45% or less, such as 40% or less, such as 35% or less, such as 30% or less, such as 25% or less, such as 20% or less, such as 15% or less. The compression set may be 5% or more, such as 8% or more, such as 10% or more, such as 13% or more, such as 15% or more, such as 18% or more, such as 20% or more, such as 25% or more, such as 30% or more, such as 35% or more, such as 40% or more, such as 50% or more, such as 60% or more, such as 70% or more. The compression set may be determined in accordance with ASTM D395B-18 (Type 1 Specimen, 25%, 22 hours). Such aforementioned compression set is based on a temperature of room temperature, 70° C., and/or 110° C. In this regard, such compression set may be realized at least at one, such as at least at two, such as at all three temperature conditions in one embodiment.

The thermoplastic vulcanizate may also be characterized by an advantageously high tear strength. For instance, the tear strength may be 50 N/cm or more, such as 100 N/cm or more, such as 150 N/cm or more, such as 200 N/cm or more, such as 250 N/cm or more, such as 300 N/cm or more, such as 350 N/cm or more, such as 400 N/cm or more, such as 450 N/cm or more, such as 500 N/cm or more, such as 550 N/cm or more, such as 600 N/cm or more, such as 650 N/cm or more. The tear strength may be 1200 N/cm or less, such as 1100 N/cm or less, such as 1000 N/cm or less, such as 900 N/cm or less, such as 800 N/cm or less, such as 700 N/cm or less, such as 650 N/cm or less, such as 600 N/cm or less, such as 550 N/cm or less, such as 500 N/cm or less, such as 450 N/cm or less, such as 400 N/cm or less, such as 350 N/cm or less, such as 300 N/cm or less. The tear strength may be determined in accordance with ASTM D624 (Die C, across flow).

The thermoplastic vulcanizate may also be characterized by a specific gravity, as determined according to ASTM D-792, of 0.900 g/cm³ or more, such as 0.91 g/cm³ or more, such as 0.915 g/cm³ or more, such as 0.92 g/cm³ or more, such as 0.925 g/cm³ or more, such as 0.93 g/cm³ or more, such as 0.935 g/cm³ or more, such as 0.94 g/cm³ or more, such as 0.945 g/cm³ or more, such as 0.95 g/cm³ or more, such as 0.965 g/cm³ or more, such as 0.97 g/cm³ or more, such as 0.975 g/cm³ or more, such as 0.98 g/cm³ or more. The specific gravity may be 1.1 g/cm³ or less, such as 1.05 g/cm³ or less, such as 1 g/cm³ or less, such as 0.995 g/cm³ or less, such as 0.99 g/cm³ or less, such as 0.985 g/cm³ or less, such as 0.98 g/cm³ or less, such as 0.975 g/cm³ or less, such as 0.97 g/cm³ or less, such as 0.965 g/cm³ or less, such as 0.96 g/cm³ or less.

The thermoplastic vulcanizate may also be characterized by a weight gain, as determined according to ASTM D471 for 24 hours at 121° C. using IRM903 oil. Such weight percentage provides the percent by weight of oil swell as an implicit measure of the degree of curing or crosslinking of the elastomer. Generally, low or partial crosslinking of elastomer yields higher oil swell values, whereas highly crosslinked dispersed elastomer will have a lower oil swell. In this regard, the wt. gain may be 10% or more, such as 20% or more, such as 30% or more, such as 40% or more, such as 50% or more, such as 60% or more, such as 70% or more, such as 80% or more, such as 90% or more, such as 100% or more. The weight gain may be 150% or less, such as 130% or less, such as 110% or less, such as 100% or less, such as 90% or less, such as 80% or less, such as 70% or less, such as 60% or less, such as 50% or less, such as 40% or less.

The thermoplastic vulcanizate may also be characterized by an LCR viscosity, as determined according to ASTM D-3835 at 204° C. using a die with a 1 mm diameter, 30 mm length 180° entry angle. For instance, the LCR viscosity at 1200s-1 may be 30 Pas or more, such as 40 Pa·s or more, such as 50 Pa·s or more, such as 60 Pa·s or more, such as 70 Pa·s or more, such as 80 Pa·s or more, such as 85 Pa·s or more, such as 90 Pa·s or more, such as 95 Pa·s or more, such as 100 Pa·s or more. The LCR viscosity at 1200s-1 may be 200 Pa·s or less, such as 180 Pa·s or less, such as 160 Pa·s or less, such as 140 Pa·s or less, such as 130 Pa·s or less, such as 120 Pa·s or less, such as 115 Pa·s or less, such as 110 Pa·s or less, such as 105 Pa·s or less, such as 100 Pa·s or less, such as 95 Pa·s or less.

The LCR viscosity at 200s-1 may be 200 Pa·s or more, such as 250 Pa·s or more, such as 300 Pa·s or more, such as 320 Pa·s or more, such as 340 Pa·s or more, such as 360 Pa·s or more, such as 370 Pa·s or more, such as 380 Pa·s or more, such as 390 Pa·s or more, such as 400 Pa·s or more. The LCR viscosity at 200s-1 may be 700 Pa·s or less, such as 650 Pa·s or less, such as 600 Pa·s or less, such as 550 Pa·s or less, such as 500 Pa·s or less, such as 480 Pa·s or less, such as 460 Pa·s or less, such as 440 Pa·s or less, such as 430 Pas or less, such as 420 Pa·s or less, such as 415 Pa·s or less, such as 410 Pa·s or less, such as 405 Pa·s or less, such as 400 Pa·s or less, such as 395 Pa·s or less, such as 390 Pa·s or less, such as 385 Pa·s or less, such as 380 Pa·s or less, such as 370 Pa·s or less, such as 360 Pa·s or less, such as 350 Pa·s or less.

The thermoplastic vulcanizate may also be characterized by an extrusion surface roughness (ESR). The ESR may dictate the dictate the suitability and aesthetics of a final extruded product. In this regard, the ESR may be 300 pin or less, such as 280 μin or less, such as 260 μin or less, such as 240 μin or less, such as 220 μin or less, such as 200 μin or less, such as 180 μin or less, such as 160 μin or less, such as 140 μin or less, such as 130 μin or less, such as 120 μin or less, such as 110 μin or less, such as 100 μin or less, such as 90 μin or less, such as 80 μin or less, such as 70 μin or less, such as 60 μin or less, such as 50 μin or less, such as 40 μin or less. The ESR may be 0.1 μin or more, such as 0.5 μin or more, such as 1 μin or more, such as 5 μin or more, such as 10 μin or more, such as 20 μin or more, such as 30 μin or more, such as 40 μin or more, such as 50 μin or more, such as 60 μin or more, such as 70 μin or more, such as 80 μin or more, such as 90 μin or more, such as 100 μin or more, such as 110 μin or more, such as 120 μin or more, such as 130 μin or more, such as 140 μin or more, such as 150 μin or more, such as 170 μin or more, such as 190 μin or more, such as 210 μin or more, such as 230 μin or more.

The following test methods may be employed to determine the properties referenced herein.

### Test Methods

Melting Temperature, Glass Transition Temperature, Heat of Fusion: The melting temperature (“Tm”), glass transition temperature (“Tg”), and the heat of fusion (“Hf”) may be determined by differential scanning calorimetry (“DSC”) as is known in the art using commercially available equipment such as a TA Instruments Model Q100. Typically, 6 to 10 mg of the sample, that has been stored at room temperature (about 23° C.) for at least 48 hours, is sealed in an aluminum pan and loaded into the instrument at room temperature (about 23° C.). The sample is equilibrated at 25° C. and then it is cooled at a cooling rate of 10° C./min to −80° C. The sample is held at −80° C. for 5 min and then heated at a heating rate of 10° C./min to 25° C. The glass transition temperature is measured from this heating cycle (“first heat”). For samples displaying multiple peaks, the melting point (or melting temperature) is defined to be the peak melting temperature associated with the largest endothermic calorimetric response in that range of temperatures from the DSC melting trace. The Tg was measured by again heating the sample from −80° C. to 80° C. at a rate of 20° C./min (“second heat”). The glass transition temperature reported is the midpoint of step change when heated during the second heating cycle. Areas under the DSC curve are used to determine the heat of transition (heat of fusion, Hf, upon melting or heat of crystallization, Hc, upon crystallization, if the Hf value from the melting is different from the Hc value obtained for the heat of crystallization, then the value from the melting (Tm) shall be used), which can be used to calculate the degree of crystallinity (also called the percent crystallinity). The percent crystallinity (X %) is calculated using the formula: [area under the curve (in J/g)/H° (in J/g)]*100, where He is the heat of fusion for the homopolymer of the major monomer component. These values for H° are to be obtained from the Polymer Handbook, Fourth Edition, published by John Wiley and Sons, New York 1999, except that a value of 290 J/g is used as the equilibrium heat of fusion (H°) for 100% crystalline polyethylene, a value of 140 J/g is used as the equilibrium heat of fusion (H°) for 100% crystalline polybutene, and a value of 207 J/g (H°) is used as the heat of fusion for a 100% crystalline polypropylene.

Extrusion Surface Roughness: Approximately 1 kg (2 lbs.) of the TPV to be tested was fed into a 1″ or 1½″ diameter extruder equipped with a 24:1 L/D screw having a 3.0 to 3.5 compression ratio. The extruder was fitted with a strip die 25.4 mm (1″) wide×0.5 mm (0.019″) thick×7 to 10 mm (0.25 to 0.40″) land length. A breaker plate was used with the die, but no screen pack was placed in front of the breaker plate. Temperature profiles of the extruder were as follows: Zone 1=180° C. . . . (feed zone); Zone 2-190° C. (feed zone); Zone 3-200° C. (feed zone); Zone 4=205° C. (die zone). When the zone temperatures were reached, the screw was activated. Screw speed was set to maintain an output of approximately 50 grams per minute. After flushing the extruder for 5 minutes, the extruded material was discarded and a strip approximately 30.5 cm (12″) in length was extruded on a flat substrate placed directly under and touching the under side of the die. Three representative samples were collected in this manner. ESR was measured on the samples using a model EMD-04000-W5 Surfanalyzer System 4000 including a universal probe 200 mg stylus force and a Surfanalyzer probe tip type EPT-01049 (0.025 mm [0.0001″] stylus radius).

### EXAMPLES

### Example 1

The components identified in the table provided below were melt blended and dynamically cured to provide a thermoplastic vulcanizate including an at least partially cured EPDM. As indicated below, Examples 1-5 included a re-refined oil. The melt blending and dynamic vulcanization was conducted using a twin-screw extruder set at a temperature of from 90° C. through 210° C. The speed was set to about 300 rpm. The samples were then injection molded into plaques and specimens were punched from the plaques and tested.

To assess short-term aging performance, the samples were heat aged in an air circulating oven for 168 hrs at 70° C. and 110° C. To assess long-term aging performance, the samples were heat aged in an air circulating oven for 1000 hrs at 100° C.

| | | | | | | | |
|---|---|---|---|---|---|---|---|
| C Ex 1 | Ex 1 | Ex 2 | Ex 3 | C Ex 2 | Ex 4 | C Ex 3 | Ex 5 |

phr

| | | | | | | | | |
|---|---|---|---|---|---|---|---|---|
| EPDM | 100 | 100 | 100 | 100 | 100 | 100 | 100 | 100 |
| Virgin Oil | 113 | — | — | — | 128 | — | 125 | — |
| Re-refined Oil 1, | — | 113 | 113 | 113 | — | 128 | — | 125 |
| Re-refined Oil 2, or | | | | | | | | |
| Re-refined Oil 3 | | | | | | | | |
| Clay | 48 | 48 | 48 | 48 | 48 | 48 | 48 | 48 |
| ZnO | 1.5 | 1.5 | 1.5 | 1.5 | 1.5 | 1.5 | 2.0 | 2.0 |
| Carbon Black in | 7 | 7 | 7 | 7 | 24 | 24 | 21 | 21 |
| Polypropylene | | | | | | | | |
| Masterbatch | | | | | | | | |
| SnCl₂ in | 1.7 | 1.7 | 1.7 | 1.7 | 1.7 | 1.7 | 2.2 | 2.2 |
| Polypropylene | | | | | | | | |
| Masterbatch | | | | | | | | |
| Phenolic Resin in | 12.6 | 12.6 | 12.6 | 12.6 | 10.0 | 10.0 | 15.3 | 15.3 |
| Oil | | | | | | | | |
| Recycled | 73 | 73 | 73 | 73 | 34 | 34 | 270 | 270 |
| Polypropylene | | | | | | | | |
| Polyethylene | 45 | 45 | 45 | 45 | 17 | 17 | 120 | 120 |
| Total parts | 401.8 | 401.8 | 401.8 | 401.8 | 364.2 | 364.2 | 703.5 | 703.5 |

wt. %

| | | | | | | | | |
|---|---|---|---|---|---|---|---|---|
| EPDM | 24.9 | 24.9 | 24.9 | 24.9 | 27.5 | 27.5 | 14.2 | 14.2 |
| Virgin Oil | 28.1 | — | — | — | 35.1 | — | 17.8 | — |
| Re-refined Oil 1, | — | 28.1 | 28.1 | 28.1 | — | 35.1 | — | 17.8 |
| Re-refined Oil 2, or | | | | | | | | |
| Re-refined Oil 3 | | | | | | | | |
| Clay | 11.9 | 11.9 | 11.9 | 11.9 | 13.2 | 13.2 | 6.8 | 6.8 |
| ZnO | 0.4 | 0.4 | 0.4 | 0.4 | 0.4 | 0.4 | 0.3 | 0.3 |
| Carbon Black in | 1.7 | 1.7 | 1.7 | 1.7 | 6.6 | 6.6 | 3.0 | 3.0 |
| Polypropylene | | | | | | | | |
| Masterbatch | | | | | | | | |
| SnCl₂ in | 0.4 | 0.4 | 0.4 | 0.4 | 0.5 | 0.5 | 0.3 | 0.3 |
| Polypropylene | | | | | | | | |
| Masterbatch | | | | | | | | |
| Phenolic Resin in | 3.1 | 3.1 | 3.1 | 3.1 | 2.7 | 2.7 | 2.2 | 2.2 |
| Oil | | | | | | | | |
| Recycled | 18.2 | 18.2 | 18.2 | 18.2 | 9.3 | 9.3 | 38.4 | 38.4 |
| Polypropylene | | | | | | | | |
| Polyethylene | 11.2 | 11.2 | 11.2 | 11.2 | 4.7 | 4.7 | 17.1 | 17.1 |
| Total wt. % | 100 | 100 | 100 | 100 | 100 | 100 | 100 | 100 |
| Total Recycled | 18.2% | 46.2% | 46.2% | 46.2% | 9.3% | 44.5% | 38.4% | 56.1% |
| Content | | | | | | | | |
| Estimated CO₂ | 1.55 | 1.38 | 1.38 | 1.38 | 1.56 | 1.35 | 1.49 | 1.38 |
| Footprint, | | | | | | | | |
| kgCO₂eq/kg | | | | | | | | |
| Specific Gravity | 0.963 | 0.945 | 0.936 | 0.948 | 0.951 | 0.941 | 0.932 | 0.932 |
| Hardness, Shore A, | 79 | 78 | 78 | 78 | 64 | 63 | 94 | 94 |
| Unaged (15 | | | | | | | | |
| seconds) | | | | | | | | |
| Hardness, Shore D, | | | | | | | 37 | 37 |
| Unaged (15 | | | | | | | | |
| seconds) | | | | | | | | |
| 100% Modulus, | 3.9 | 3.7 | 3.7 | 3.7 | 2.2 | 2.3 | 8.0 | 7.9 |
| MPa | | | | | | | | |
| Tensile Strength at | 7.9 | 7.6 | 7.5 | 7.7 | 5.5 | 5.5 | 11.5 | 10.5 |
| Break (UTS), MPa, | | | | | | | | |
| Unaged | | | | | | | | |
| Tensile Elongation | 586 | 540 | 534 | 550 | 483 | 448 | 646 | 542 |
| at Break (UTE), %, | | | | | | | | |
| Unaged | | | | | | | | |
| Tear Strength, | 330 | 424 | 418 | 426 | 293 | 263 | 658 | 650 |
| N/cm | | | | | | | | |
| LCR Viscosity at | 405 | 400 | 399 | 385 | 402 | 399 | 323 | 347 |
| 204° C. and | | | | | | | | |
| 200 s−1, Pa · s | | | | | | | | |
| LCR Viscosity at | 106 | 107 | 105 | 102 | 105 | 101 | 100 | 97 |
| 204° C. and | | | | | | | | |
| 1200 s−1, Pa · s | | | | | | | | |
| Extrusion Surface | 114 | 137 | 152 | 112 | 237 | 241 | 60 | 40 |
| Roughness, pin | | | | | | | | |
| Compression | 23 | 23 | 22 | 22 | 17 | 18 | 36 | 40 |
| set, %, 25%, | | | | | | | | |
| 22 hrs @ RT | | | | | | | | |
| Compression | 35 | 35 | 36 | 35 | 34 | 30 | 50 | 57 |
| set, %, 25%, | | | | | | | | |
| 22 hrs @ 70° C. | | | | | | | | |
| Compression | 53 | 45 | 47 | 51 | 50 | 41 | 74 | 72 |
| set, %, 25%, | | | | | | | | |
| 22 hrs @ 110° C. | | | | | | | | |
| Δ Shore A | −0.3 | 0.6 | 0.4 | 0.0 | −0.2 | −0.2 | 0.0 | 0.0 |
| Hardness after | | | | | | | | |
| Aging 168 hrs @ | | | | | | | | |
| 70° C. | | | | | | | | |
| Δ Shore A | −0.8 | 2.8 | 2.5 | 0.5 | −2.3 | −0.8 | −0.2 | 0.4 |
| Hardness after | | | | | | | | |
| Aging 168 hrs @ | | | | | | | | |
| 110° C. | | | | | | | | |
| Δ Shore A | −0.7 | 5.2 | 4.3 | 1.1 | −3.1 | 3.0 | −0.3 | 0.5 |
| Hardness after | | | | | | | | |
| Aging 1000 hrs @ | | | | | | | | |
| 100° C. | | | | | | | | |
| % Δ UTS after | 0% | −3% | −19% | 3% | 0% | −4% | −1% | 1% |
| Aging 168 hrs @ | | | | | | | | |
| 70° C. | | | | | | | | |
| % Δ UTS after | −3% | 14% | 15% | 3% | −5% | −2% | −3% | 4% |
| Aging 168 hrs @ | | | | | | | | |
| 110° C. | | | | | | | | |
| % Δ UTS after | −5% | 25% | 25% | 8% | −7% | 11% | −8% | 7% |
| Aging 1000 hrs @ | | | | | | | | |
| 100° C. | | | | | | | | |
| % Δ UTE after | 1% | −1% | −4% | 3% | −4% | −1% | 11% | 23% |
| Aging 168 hrs @ | | | | | | | | |
| 70° C. | | | | | | | | |
| % Δ UTE after | 29% | 40% | 36% | 29% | 18% | 25% | 4% | 18% |
| Aging 168 hrs @ | | | | | | | | |
| 110° C. | | | | | | | | |
| % Δ UTE after | 19% | 44% | 40% | 32% | −3% | 27% | −20% | 22% |
| Aging 1000 hrs @ | | | | | | | | |
| 100° C. | | | | | | | | |

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed is:

1. A method of forming a thermoplastic vulcanizate, the method comprising:
dynamically vulcanizing a formulation comprising a thermoplastic resin, an elastomer, an oil comprising a re-refined oil, and a curing agent to provide the thermoplastic vulcanizate comprising the thermoplastic resin and an at least partially cured elastomer.

2. The method of claim 1, wherein the oil comprises a mixture of the re-refined oil and a virgin oil.

3. The method of claim 1, wherein the thermoplastic resin comprises a polyolefin.

4. The method of claim 3, wherein the polyolefin comprises polypropylene.

5. The method of claim 1, wherein the thermoplastic resin comprises a recycled thermoplastic resin.

6. The method of claim 5, wherein the recycled thermoplastic resin comprises a recycled polypropylene, a recycled polyethylene, or a mixture thereof.

7. The method of claim 1, wherein the thermoplastic resin comprises a mixture of a virgin thermoplastic resin and a recycled thermoplastic resin.

8. The method of claim 1, wherein the elastomer comprises an ethylene/propylene/non-conjugated diene copolymer rubber (EPDM).

9. The method of claim 1, wherein the re-refined oil is provided with the elastomer as a re-refined oil extended elastomer.

10. The method of claim 1, wherein the thermoplastic vulcanizate comprises from about 5 wt. % to about 90 wt. % of the elastomer, from about 5 wt. % to about 90 wt. % of the thermoplastic resin, and from about 10 wt. % or more to about 60 wt. % or less of the re-refined oil, wherein the wt. % is based on the weight of the thermoplastic vulcanizate and wherein the thermoplastic vulcanizate has a recycled content of from 5 wt. % to 95 wt. % based on the weight of the thermoplastic vulcanizate.

11. The method of claim 1, wherein the thermoplastic vulcanizate exhibits one or more of a Shore A hardness of from 25 to 100 in accordance with ASTM 2240-15 (2021) (15 seconds; unaged), a Shore D hardness of greater than 0 to 50 in accordance with ASTM 2240-15 (2021) (15 seconds; unaged), a 100% modulus of from 0.3 MPa to 50 MPa as determined in accordance with ASTM D412-16 (unaged), a tensile stress at break of from 0.5 MPa to 100 MPa as determined in accordance with ASTM D412-16 (unaged), an elongation at break of from 20% to 2000% as determined in accordance with ASTM D412-16 (unaged), or a compression set of 70% or less as determined in accordance with ASTM D395B-18 at room temperature after 22 hours.

12. A thermoplastic vulcanizate comprising a thermoplastic resin in an amount of 5 wt. % or more based on the weight of the thermoplastic vulcanizate, an at least partially cured elastomer in an amount of 5 wt. % or more based on the weight of the thermoplastic vulcanizate, and an oil comprising a re-refined oil.

13. The thermoplastic vulcanizate of claim 12, wherein the oil comprises a mixture of the re-refined oil and a virgin oil.

14. The thermoplastic vulcanizate of claim 12, wherein the thermoplastic resin comprises a polyolefin.

15. The thermoplastic vulcanizate of claim 12, wherein the thermoplastic resin comprises a recycled thermoplastic resin.

16. The thermoplastic vulcanizate of claim 15, wherein the recycled thermoplastic resin comprises a recycled polypropylene, a recycled polyethylene, or a mixture thereof.

17. The thermoplastic vulcanizate of claim 12, wherein the thermoplastic resin comprises a mixture of a virgin thermoplastic resin and a recycled thermoplastic resin.

18. The thermoplastic vulcanizate of claim 12, wherein the elastomer comprises an ethylene/propylene/non-conjugated diene copolymer rubber (EPDM).

19. The thermoplastic vulcanizate of claim 12, wherein the thermoplastic vulcanizate comprises from about 5 wt. % to about 90 wt. % of the elastomer, from about 5 wt. % to about 90 wt. % of the thermoplastic resin, and from about 10 wt. % or more to about 60 wt. % or less of the re-refined oil, wherein the wt. % is based on the weight of the thermoplastic vulcanizate and wherein the thermoplastic vulcanizate has a recycled content of from 5 wt. % to 95 wt. % based on the weight of the thermoplastic vulcanizate.

20. The thermoplastic vulcanizate of claim 12, wherein the thermoplastic vulcanizate exhibits one or more of a Shore A hardness of from 25 to 100 in accordance with ASTM 2240-15 (2021) (15 seconds; unaged), a Shore D hardness of greater than 0 to 50 in accordance with ASTM 2240-15 (2021) (15 seconds; unaged), a 100% modulus of from 0.3 MPa to 50 MPa as determined in accordance with ASTM D412-16 (unaged), a tensile stress at break of from 0.5 MPa to 100 MPa as determined in accordance with ASTM D412-16 (unaged), an elongation at break of from 20% to 2000% as determined in accordance with ASTM D412-16 (unaged), or a compression set of 70% or less as determined in accordance with ASTM D395B-18 at room temperature after 22 hours.
